(19) United States
(12) Patent Application Publication
(10) Pub. No.: US 2019/0218453 A1
(43) Pub. Date: Jul. 18, 2019

(54) FLUORESCENT NANOPARTICLES STABILIZED WITH A FUNCTIONAL AMINOSILICONE

(71) Applicant: 3M INNOVATIVE PROPERTIES COMPANY, St. Paul, MN (US)

(72) Inventors: Zai-Ming QIU, Woodbury, MN (US); Joseph M. PIEPER, Atlanta, GA (US)

(21) Appl. No.: 16/334,421

(22) PCT Filed: Sep. 14, 2017
(86) PCT No.: PCT/IB2017/055568

§ 371 Date: Mar. 19, 2019

Related U.S. Application Data
(60) Provisional application No. 62/396,401, filed on Sep. 19, 2016.

(51) Int. Cl. C09K 11/02; C09K 11/88; C08L 81/02; C08L 83/04; C08K 5/544; C08K 3/30; C08K 3/32

(52) U.S. Cl. CPC C09K 11/025; C09K 11/88; C08L 81/02; C08L 83/04; B82Y 20/00; C08K 3/30; C08K 3/32; C08L 2207/53; C08K 5/544

(57) ABSTRACT

Aminosilicones of the following formula are described, which may be used as stabilizing ligands for fluorescent nanoparticles.

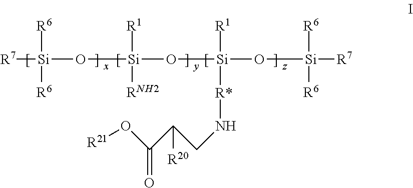

### BACKGROUND

Quantum Dot Enhancement Films (QDEF) are used in LCD displays. Red and green quantum dots in the film down-convert light from the blue LED source to give white light. This has the advantage of improving the color gamut over the typical LCD display and decreasing the energy consumption

Colloidal quantum dot nanoparticles (preferably, nanocrystals) are stabilized with one or more organic ligands to improve stability. Quantum dot ligands may also improve photoluminescent quantum yields by passivating surface traps, stabilize quantum dots against aggregation and degradation, and influence the kinetics of nanoparticle (preferably, nanocrystal) growth during synthesis. Therefore, optimizing the organic ligand or ligand system is important for achieving optimal quantum yield, processability, thermal stability, and photo lifetime stability before and after use in articles, such as in QDEF.

Quantum dot film articles include quantum dots dispersed in a matrix that is laminated between two barrier layers. The quantum dot articles, which include combinations of green and red quantum dots as fluorescing elements, can enhance color gamut performance when used in display devices such as, for example, liquid crystal displays (LCDs).

Quantum dots are highly sensitive to degradation, so the quantum dot article should have excellent barrier properties to prevent ingress of, for example, water and oxygen. The barrier layers protect the quantum dots in the interior regions of the laminate construction from damage caused by oxygen or water exposure, but the cut edges of the article expose the matrix materials to the atmosphere. In these edge regions the protection of the quantum dots dispersed in the matrix is primarily dependent on the barrier properties of the matrix itself.

If water and/or oxygen enter the edge regions of the quantum dot article, the quantum dots on or adjacent to the exposed edge of the laminate construction can degrade and ultimately fail to emit light when excited by ultraviolet or visible light below the emission wavelength of the quantum dots. This type of quantum dot degradation, referred to as edge ingress, can cause a dark line around a cut edge of the film article, which can be detrimental to performance of a display in which the quantum dot article forms a part.

### SUMMARY

Composite particles are provided that are capable of fluorescence and suitable for use in quantum dot enhancement films.

In general, the present disclosure is directed to quantum dot stabilizing ligand, derived from partial Michael addition of aminosilicone and (meth)acrylate, for use in preparing quantum dots and quantum dot articles. The quantum dot articles having the (meth)acrylate modified aminosilicone ligand in thiol-ene matrix provide significantly enhanced photo lifetime stability, greater quantum efficiency, extremely low edge ingress, and acceptable color stability upon thermal aging. In one embodiment, the present disclosure is directed to a film article including a first barrier layer; a second barrier layer; and a quantum dot layer between the first barrier layer and the second barrier layer. The quantum dot layer includes fluorescent nanoparticles stabilized with a (meth)acrylate modified aminosilicone ligand (quantum dots) and dispersed in a matrix derived from a cured thiol-ene resin.

In one aspect, the present disclosure provides a composite particle that includes: a fluorescent semiconductor core/shell nanoparticle (preferably, nanocrystal); and a stabilizing ligand comprising the partial Michael-adduct of an aminosilicone.

In one embodiment, the stabilizing ligand is of the formula:

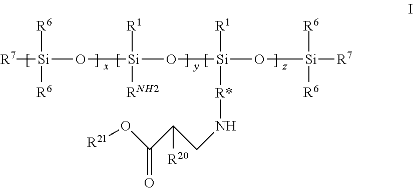

each R⁶ is independently an alkyl or aryl;
R^{NH2} is an amine-substituted (hetero)hydrocarbyl group;
R* is a (hetero)hydrocarbyl group derived from R^{NH2};
R²⁰ is H or C₁-C₄ alkyl;
R²¹ is a hydrocarbyl group, including alkyl and aryl or a a silyl-substituted hydrocarbyl group;
x is 1 to 2000; preferably 3 to 100;
y may be zero;

x+y is at least one;

z is at least one;
R⁷ is alkyl, aryl, R^{NH2} or

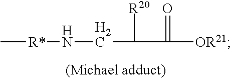

wherein amine-functional silicone has at least two R^{NH2} groups.

It will be understood that R* is the (hetero)hydrocarbyl residue of the R^{NH2} group after Michael addition of the amine group of R^{NH2} to the (meth)acrylate ester. In some embodiment R²¹ may be a silyl-substituted hydrocarbyl group, including siloxane-substituted hydrocarbyl. In such embodiments R²¹ may be designated as R^{Silyl}.

In some embodiments the Michael adduct may be derived from aminosilicones having terminal amine groups that will provide Michael adduct ligands of the Formulas:

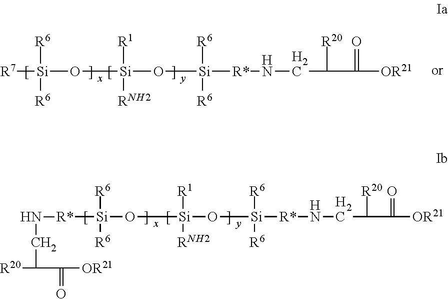

wherein
each R⁶ is independently an alkyl or aryl;
R^{NH2} is an amine-substituted (hetero)hydrocarbyl group;
R* is a (hetero)hydrocarbyl group;
R²⁰ is H or C₁-C₄ alkyl;
R²¹ is a hydrocarbyl group, including alkyl and aryl or a silyl-substituted hydrocarbyl group;
x is 1 to 2000; preferably 3 to 100;
y may be zero;
x+y is at least one;
z is at least one;
wherein the functional aminesilicone has at least two R^{NH2} groups.

With respect to Formulas Ia and Ib, a portion of the pendent amine groups having the subscript y may be functionalized by Michael addition.

The present disclosure further provides a composite particle that includes: a fluorescent semiconductor core/shell nanoparticle (preferably, nanocrystal); and a stabilizing ligand of Formula I. In some embodiments the amount of ligand of Formula I is ≥60 wt. %, preferably ≥70 wt. %, more preferably ≥80 wt. %, relative to the total including the fluorescent nanoparticles. In other words, the ligand stabilized quantum dots comprise ≥60 wt. % of ligand compound of Formula I, relative to the total weight of the quantum dot composite.

In a further embodiment, this disclosure provides a composition wherein the stabilized quantum dot composites comprising the fluorescent nanoparticles stabilized with the ligand of Formula I. Droplets of the composites may then be dispersed in an uncured thiol-ene resin and cured to provide droplets of the stabilized composites dispersed in t thiol-ene matrix.

In a preferred embodiment, the fluorescent semiconductor core/shell nanoparticle includes: a CdSe core; an inner shell overcoating the core, wherein the inner shell includes ZnSe; and an outer shell overcoating the inner shell, wherein the outer shell includes ZnS.

As used herein

“Alkyl” means a linear or branched, cyclic or acylic, saturated monovalent hydrocarbon.

“Alkylene” means a linear or branched unsaturated divalent hydrocarbon.

“Alkenyl” means a linear or branched unsaturated hydrocarbon.

“Aryl” means a monovalent aromatic, such as phenyl, naphthyl and the like.

“Arylene” means a polyvalent, aromatic, such as phenylene, naphthalene, and the like.

“Aralkylene” means a group defined above with an aryl group attached to the alkylene, e.g., benzyl, 1-naphthylethyl, and the like.

As used herein, “(hetero)hydrocarbyl” is inclusive of hydrocarbyl alkyl, aryl, aralkyl and alkaryl groups, and heterohydrocarbyl heteroalkyl and heteroaryl groups, the later comprising one or more catenary (in-chain) heteroatoms such as ether or amino groups. Heterohydrocarbyl may optionally contain one or more catenary (in-chain) functional groups including ester, amide, urea, urethane, and carbonate functional groups. Unless otherwise indicated, the non-polymeric (hetero)hydrocarbyl groups typically contain from 1 to 60 carbon atoms. Some examples of such heterohydrocarbyls as used herein include, but are not limited to, methoxy, ethoxy, propoxy, 4-diphenylaminobutyl, 2-(2′-phenoxyethoxy)ethyl, 3,6-dioxaheptyl, 3,6-dioxahexyl-6-phenyl, in addition to those described for “alkyl”, “heteroalkyl”, and “aryl” supra.

The term “composite particle” as used herein refers to a nanoparticle, which is typically in the form of a core/shell nanoparticle (preferably, nanocrystal), having any associated organic ligand coating or other material on the surface of the nanoparticle that is not removed from the surface by ordinary solvation. Such composite particles are useful as “quantum dots,” which have a tunable emission in the near ultraviolet (UV) to far infrared (IR) range as a result of the use of a semiconductor material.

The term “nanoparticle” refers to a particle having an average particle diameter in the range of 0.1 to 1000 nanometers such as in the range of 0.1 to 100 nanometers or in the range of 1 to 100 nanometers. The term “diameter” refers not only to the diameter of substantially spherical particles but also to the distance along the smallest axis of the structure. Suitable techniques for measuring the average particle diameter include, for example, scanning tunneling microscopy, light scattering, and transmission electron microscopy.

A “core” of a nanoparticle is understood to mean a nanoparticle (preferably, a nanocrystal) to which no shell has been applied or to the inner portion of a core/shell nanoparticle. A core of a nanoparticle can have a homogenous composition or its composition can vary with depth inside the core. Many materials are known and used in core nanoparticles, and many methods are known in the art for applying one or more shells to a core nanoparticle. The core has a different composition than the one more shells. The core typically has a different chemical composition than the shell of the core/shell nanoparticle.

“(Meth)acrylate” means ester of (meth)acrylate, including methacrylate and acrylate, mono(meth)acrylate and poly(meth)acrylate, such as di-, tri- and tetra-(meth)acrylates.

“Michael addition” refers to an addition reaction wherein a nucleophile (such as an fluorochemical amine) undergoes 1,4 addition to an acryloyl group (such as with an (meth)acrylate ester).

“thiol-ene” refers to the curable reaction mixture of a polythiol and a polyene compound having two or more alkenyl or alkynyl groups, and is used exclusive from thiol-ene reactions with (meth)acrylates.

The term “liquid quantum dot composite” as used herein refers to the quantum dot composite (including red and green quantum dots) in liquid form by having at least one or more liquid polymeric or oligomeric ligands having viscosity less than 3000 psi.

Preferably, the liquid polymeric or oligomeric ligands have low reflective index, no more than 1.45.

### BRIEF DESCRIPTION OF THE DRAWINGS

FIG. 1 is a schematic side elevation view of an edge region of an illustrative film article including quantum dots.

FIG. 2 is a flow diagram of an illustrative method of forming a quantum dot film.

FIG. 3 is a schematic illustration of an embodiment of a display including a quantum dot article.

FIG. 4 illustrates the white point (color) measurement system.

FIG. 5 is the normalized EQE vs. time of Examples 1-4 and CE-A of the Accelerated Aging Test.

FIG. 6 is the normalized Delta9x,y) vs. time of Examples 1-4 and CE-A of the Accelerated Aging Test.

FIG. 7 is the normalized EQE versus time of EX10-EX11 and CE-A from Accelerated Aging Test II.

FIG. 8 is normalized EQE versus time of EX10-EX11 and CE-A from Accelerated Aging Test II.

### DETAILED DESCRIPTION

The present disclosure provides composite particles that contain fluorescent semiconductor nanoparticles that can fluoresce when excited with actinic radiation. The composite particles can be used in coatings and films for use in optical displays.

Fluorescent semiconductor nanoparticles emit a narrow or sharp fluorescence signal controlled by particle size when suitably excited. They fluoresce at a second wavelength of actinic radiation when excited by a first wavelength of actinic radiation that is shorter than the second wavelength. In some embodiments, the fluorescent semiconductor nanoparticles can fluoresce in the visible region of the electromagnetic spectrum when exposed to wavelengths of light in the ultraviolet region of the electromagnetic spectrum. In other embodiments, the fluorescent semiconductor nanoparticles can fluoresce in the infrared region when excited in the ultraviolet or visible regions of the electromagnetic spectrum. In still other embodiments, the fluorescent semiconductor nanoparticles can fluoresce in the ultraviolet region when excited in the ultraviolet region by a shorter wavelength of light, can fluoresce in the visible region when excited by a shorter wavelength of light in the visible region, or can fluoresce in the infrared region when excited by a shorter wavelength of light in the infrared region. The fluorescent semiconductor nanoparticles are often capable of fluorescing in a wavelength range such as, for example, at a wavelength up to 1200 nanometers (nm), or up to 1000 nm, up to 900 nm, or up to 800 nm. For example, the fluorescent semiconductor nanoparticles are often capable of fluorescence in the range of 400 to 800 nanometers.

The nanoparticles have an average particle diameter of at least 0.1 nanometer (nm), or at least 0.5 nm, or at least 1 nm. The nanoparticles have an average particle diameter of up to 1000 nm, or up to 500 nm, or up to 200 nm, or up to 100 nm, or up to 50 nm, or up to 20 nm, or up to 10 nm. Semiconductor nanoparticles, particularly with sizes on the scale of 1-10 nm, have emerged as a category of the most promising advanced materials for cutting-edge technologies.

Semiconductor materials include elements or complexes of Group 2-Group 16, Group 12-Group 16, Group 13-Group 15, Group 14-Group 16, and Group 14 semiconductors of the Periodic Table (using the modern group numbering system of 1-18). Some suitable quantum dots include a metal phosphide, a metal selenide, a metal telluride, or a metal sulfide. Exemplary semiconductor materials include, but are not limited to, Si, Ge, Sn, BN, BP, BAs, AlN, AlP, AlAs, AlSb, GaN, GaP, GaAs, GaSb, InN, InP, InAs, InSb, AlN, AlP, AlAs, AlSb, GaN, GaP, GaAs, GaSb, ZnO, ZnS, ZnSe, ZnTe, CdS, CdSe, CdTe, HgS, HgSe, HgTe, BeS, BeSe, BeTe, MgS, MgSe, MgTe, GeS, GeSe, GeTe, SnS, SnSe, SnTe, PbO, PbS, PbSe, PbTe, CuF, CuCI, CuBr, CuI, Si₃N₄, Ge₃N₄, Al₂O₃, (Ga,In)₂(S,Se,Te)₃, Al₂CO, CaS, CaSe, CaTe, SrS, SrSe, SrTe, BaS, BaSe, BaTe, and an appropriate combination of two or more such semiconductors. These semiconductor materials can be used for the core, the one or more shell layers, or both.

In certain embodiments, exemplary metal phosphide quantum dots include indium phosphide and gallium phosphide, exemplary metal selenide quantum dots include cadmium selenide, lead selenide, and zinc selenide, exemplary metal sulfide quantum dots include cadmium sulfide, lead sulfide, and zinc sulfide, and exemplary metal telluride quantum dots include cadmium telluride, lead telluride, and zinc telluride. Other suitable quantum dots include gallium arsenide and indium gallium phosphide. Exemplary semiconductor materials are commercially available from Evident Thermoelectrics (Troy, N.Y.), and from Nanosys Inc., Milpitas, Calif.

Nanocrystals (or other nanostructures) for use in the present invention can be produced using any method known to those skilled in the art. Suitable methods are disclosed in U.S. Pat. No. 6,949,206 (Whiteford, incorporated by reference herein in their entireties. The nanocrystals (or other nanostructures) for use in the present invention can be produced from any suitable material, suitably an inorganic material, and more suitably an inorganic conductive or semiconductive material. Suitable semiconductor materials include those disclosed in and include any type of semiconductor, including group 12-16, group 13-15, group 14-16 and group 14 semiconductors.

Suitable semiconductor materials include, but are not limited to, Si, Ge, Sn, Se, Te, B, C (including diamond), P, BN, BP, BAs, AlP, AlAs, AlSb, GaN, GaP, GaAs, GaSb, InN, InP, InAs, InSb, AlN, AlP, ZnO, ZnS, ZnSe, ZnTe, CdS, CdSe, CdTe, HgS, HgSe, HgTe, BeS, BeSe, BeTe, MgS, MgSe, GeS, GeSe, GeTe, SnS, SnSe, SnTe, PbO, PbS, PbSe, PbTe, CuF, CuCl, CuBr, CuI, Si₃N₄, Ge₃N₄, Al₂O₃, (Ga, In)₂(S, Se, Te)₃, Al₂CO, and an appropriate combination of two or more such semiconductors.

In certain aspects, the semiconductor nanocrystals or other nanostructures may comprise a dopant from the group consisting of: a p-type dopant or an n-type dopant. The nanocrystals (or other nanostructures) useful in the present invention can also comprise Group 12-Group 16 or Group 13-Group 15 semiconductors. Examples of Group 12-Group 16 or Group 13-Group 15 semiconductor nanocrystals and nanostructures include any combination of an element from Group 12, such as Zn, Cd and Hg, with any element from Group 16, such as S, Se, Te, Po, of the Periodic Table; and any combination of an element from Group 13, such as B, Al, Ga, In, and Tl, with any element from Group 15, such as N, P, As, Sb and Bi, of the Periodic Table.

Other suitable inorganic nanostructures include metal nanostructures. Suitable metals include, but are not limited to, Ru, Pd, Pt, Ni, W, Ta, Co, Mo, Ir, Re, Rh, Hf, Nb, Au, Ag, Ti, Sn, Zn, Fe, and the like.

While any known method can be used to create nanocrystal phosphors, suitably, a solution-phase colloidal method for controlled growth of inorganic nanomaterial phosphors is used. See Alivisatos, A. P., “Semiconductor clusters, nanocrystals, and quantum dots,” Science 271:933 (1996); X. Peng, M. Schlamp, A. Kadavanich, A. P. Alivisatos, “Epitaxial growth of highly luminescent CdSe/CdS Core/Shell nanocrystals with photostability and electronic accessibility,” J. Am. Chem. Soc. 30:7019-7029 (1997); and C. B. Murray, D. J. Norris, M. G. Bawendi, “Synthesis and characterization of nearly monodisperse CdE (E=sulfur, selenium, tellurium) semiconductor nanocrystallites,” J. Am. Chem. Soc. 115:8706 (1993). This manufacturing process technology leverages low cost proccessability without the need for clean rooms and expensive manufacturing equipment. In these methods, metal precursors that undergo pyrolysis at high temperature are rapidly injected into a hot solution of organic surfactant molecules. These precursors break apart at elevated temperatures and react to nucleate nanocrystals. After this initial nucleation phase, a growth phase begins by the addition of monomers to the growing crystal. The result is freestanding crystalline nanoparticles in solution that have an organic surfactant molecule coating their surface.

Utilizing this approach, synthesis occurs as an initial nucleation event that takes place over seconds, followed by crystal growth at elevated temperature for several minutes. Parameters such as the temperature, types of surfactants present, precursor materials, and ratios of surfactants to monomers can be modified so as to change the nature and progress of the reaction. The temperature controls the structural phase of the nucleation event, rate of decomposition of precursors, and rate of growth. The organic surfactant molecules mediate both solubility and control of the nanocrystal shape.

In semiconductor nanocrystals, photo-induced emission arises from the band edge states of the nanocrystal. The band-edge emission from nanocrystals competes with radiative and non-radiative decay channels originating from surface electronic states. [X. Peng, et al., J. Am. Chem. Soc. 30:7019-7029 (1997)]. As a result, the presence of surface defects such as dangling bonds provide non-radiative recombination centers and contribute to lowered emission efficiency. An efficient and permanent method to passivate and remove the surface trap states is to epitaxially grow an inorganic shell material on the surface of the nanocrystal. (X. Peng, et al., supra). The shell material can be chosen such that the electronic levels are type I with respect to the core material (e.g., with a larger bandgap to provide a potential step localizing the electron and hole to the core). As a result, the probability of non-radiative recombination can be reduced.

Core-shell structures are obtained by adding organometallic precursors containing the shell materials to a reaction mixture containing the core nanocrystal. In this case, rather than a nucleation-event followed by growth, the cores act as the nuclei, and the shells grow from their surface. The temperature of the reaction is kept low to favor the addition of shell material monomers to the core surface, while preventing independent nucleation of nanocrystals of the shell materials. Surfactants in the reaction mixture are present to direct the controlled growth of shell material and ensure solubility. A uniform and epitaxially grown shell is obtained when there is a low lattice mismatch between the two materials. Additionally, the spherical shape acts to minimize interfacial strain energy from the large radius of curvature, thereby preventing the formation of dislocations that could degrade the optical properties of the nanocrystal system.

In suitable embodiments, ZnS can be used as the shell material using known synthetic processes, resulting in a high-quality emission. As above, if necessary, this material can be easily substituted, e.g., if the core material is modified. Additional exemplary core and shell materials are described herein and/or known in the art.

For many applications of quantum dots, two factors are typically considered in selecting a material. The first factor is the ability to absorb and emit visible light. This consideration makes InP a highly desirable base material. The second factor is the material's photoluminescence efficiency (quantum yield). Generally, Group 12-16 quantum dots (such as cadmium selenide) have higher quantum yield than Group 13-15 quantum dots (such as InP). The quantum yield of InP cores produced previously has been very low (<1%), and therefore the production of a core/shell structure with InP as the core and another semiconductor compound with higher bandgap (e.g., ZnS) as the shell has been pursued in attempts to improve the quantum yield.

Thus, the fluorescent semiconductor nanoparticles (i.e., quantum dots) of the present disclosure include a core and a shell at least partially surrounding the core. The core/shell nanoparticles can have two distinct layers, a semiconductor or metallic core and a shell surrounding the core of an insulating or semiconductor material. The core often contains a first semiconductor material and the shell often contains a second semiconductor material that is different than the first semiconductor material. For example, a first Group 12-16 (e.g., CdSe) semiconductor material can be present in the core and a second Group 12-16 (e.g., ZnS) semiconductor material can be present in the shell.

In certain embodiments the core includes a metal phosphide (e.g., indium phosphide (InP), gallium phosphide (GaP), aluminum phosphide (AlP)), a metal selenide (e.g., cadmium selenide (CdSe), zinc selenide (ZnSe), magnesium selenide (MgSe)), or a metal telluride (e.g., cadmium telluride (CdTe), zinc telluride (ZnTe)). In certain embodiments, the core includes a metal phosphide (e.g., indium phosphide) or a metal selenide (e.g., cadmium selenide). In certain preferred embodiments of the present disclosure, the core includes a metal phosphide (e.g., indium phosphide).

The shell can be a single layer or multilayered. In some embodiments, the shell is a multilayered shell. The shell can include any of the core materials described herein. In certain embodiments, the shell material can be a semiconductor material having a higher bandgap energy than the semiconductor core. In other embodiments, suitable shell materials can have good conduction and valence band offset with respect to the semiconductor core, and in some embodiments, the conduction band can be higher and the valence band can be lower than those of the core. For example, in certain embodiments, semiconductor cores that emit energy in the visible region such as, for example, CdS, CdSe, CdTe, ZnSe, ZnTe, GaP, InP, or GaAs, or near IR region such as, for example, InP, InAs, InSb, PbS, or PbSe may be coated with a shell material having a bandgap energy in the ultraviolet regions such as, for example, ZnS, GaN, and magnesium chalcogenides such as MgS, MgSe, and MgTe. In other embodiments, semiconductor cores that emit in the near IR region can be coated with a material having a bandgap energy in the visible region such as CdS or ZnSe.

Formation of the core/shell nanoparticles may be carried out by a variety of methods. Suitable core and shell precursors useful for preparing semiconductor cores are known in the art and can include Group 2 elements, Group 12 elements, Group 13 elements, Group 14 elements, Group 15 elements, Group 16 elements, and salt forms thereof. For example, a first precursor may include metal salt (M+X−) including a metal atom (M+) such as, for example, Zn, Cd, Hg, Mg, Ca, Sr, Ba, Ga, In, Al, Pb, Ge, Si, or in salts and a counter ion (X−), or organometallic species such as, for example, dialkyl metal complexes. The preparation of a coated semiconductor nanocrystal core and core/shell nanocrystals can be found in, for example, Dabbousi et al. (1997) J. Phys. Chem. B 101:9463, Hines et al. (1996) J. Phys. Chem. 100: 468-471, and Peng et al. (1997) J. Amer. Chem. Soc. 119:7019-7029, as well as in U.S. Pat. No. 8,283,412 (Liu et al.) and International Publication No. WO 2010/039897 (Tulsky et al.).

In certain preferred embodiments the shell includes a metal sulfide (e.g., zinc sulfide, magnesium sulfide or cadmium sulfide). In certain embodiments, the shell includes a zinc-containing compound (e.g., zinc sulfide or zinc selenide). In certain embodiments, a multilayered shell includes an inner shell overcoating the core, wherein the inner shell includes zinc selenide and zinc sulfide. In certain embodiments, a multilayered shell includes an outer shell overcoating the inner shell, wherein the outer shell includes zinc sulfide.

In some embodiments, the core of the shell/core nanoparticle contains a metal phosphide such as indium phosphide, gallium phosphide, or aluminum phosphide. The shell contains zinc sulfide, zinc selenide, or a combination thereof. In some more particular embodiments, the core contains indium phosphide and the shell is multilayered with the inner shell containing both zinc selenide and zinc sulfide and the outer shell containing zinc sulfide.

The thickness of the shell(s) may vary among embodiments and can affect fluorescence wavelength, quantum yield, fluorescence stability, and other photostability characteristics of the nanocrystal. The skilled artisan can select the appropriate thickness to achieve desired properties and may modify the method of making the core/shell nanoparticles to achieve the appropriate thickness of the shell(s).

The diameter of the fluorescent semiconductor nanoparticles (i.e., quantum dots) of the present disclosure can affect the fluorescence wavelength. The diameter of the quantum dot is often directly related to the fluorescence wavelength. For example, cadmium selenide quantum dots having an average particle diameter of about 2 to 3 nanometers tend to fluoresce in the blue or green regions of the visible spectrum while cadmium selenide quantum dots having an average particle diameter of about 8 to 10 nanometers tend to fluoresce in the red region of the visible spectrum.

Since carboxylic acids are often used as surfactants in the synthesis of InP/ZnS core/shell particles, the quantum dots may have acid functional ligands attached thereto, prior to dispersing in the stabilizing agent. Similarly, CdSe quantum dots may be functionalized with amine-functional ligands as result of their preparation. As result, the quantum dots may be functionalized with those surface modifying additives or ligands resulting from the original synthesis of the nanoparticles.

As result, the quantum dots may be surface modified with ligands of Formula III:

R¹⁵—R¹²(X)ₙ III

wherein
R¹⁵ is (hetero)hydrocarbyl group having C₂ to C₃₀ carbon atoms;
R¹² is a hydrocarbyl group including alkylene, arylene, alkarylene and aralkylene;
n is at least one;
X is a ligand group, including —CO₂H, —SO₃H, —P(O)(OH)₂, —OP(O)(OH), —OH—SH and —NH₂.

Such additional surface modifying ligands may be added when the functionalizing with the stabilizing agent of Formula I, or may be attached to the nanoparticles as result of the synthesis. Such additional surface modifying agents are present in amounts less than or equal to the weight of the instant stabilizing copolymer, preferably 10 wt. % or less, relative to the amount of the stabilizing agent.

Various methods can be used to surface modify the fluorescent semiconductor nanoparticles with the ligand compounds. In some embodiments, procedures similar to those described in U.S. Pat. No. 7,160,613 (Bawendi et al.) and U.S. Pat. No. 8,283,412 (Liu et al.) can be used to add the surface modifying agent. For example, the ligand compound and the fluorescent semiconductor nanoparticles can be heated at an elevated temperature (e.g., at least 50° C., at least 60° C., at least 80° C., or at least 90° C.) for an extended period of time (e.g., at least 1 hour, at least 5 hours, at least 10 hours, at least 15 hours, or at least 20 hours).

If desired, any by-product of the synthesis process or any solvent used in surface-modification process can be removed, for example, by distillation, rotary evaporation, or by precipitation of the nanoparticles and centrifugation of the mixture followed by decanting the liquid and leaving behind the surface-modified nanoparticles. In some embodiments, the surface-modified fluorescent semiconductor nanoparticles are dried to a powder after surface-modification. In other embodiments, the solvent used for the surface modification is compatible (i.e., miscible) with any carrier fluids used in compositions in which the nanoparticles are included. In these embodiments, at least a portion of the solvent used for the surface-modification reaction can be included in the carrier fluid in which the surface-modified, fluorescent semiconductor nanoparticles are dispersed.

The fluorescent nanoparticles are stabilized with the aminosilicone ligand of Formula I. The stabilizing ligand improves the stability of the quantum dots for their use in quantum dot articles. In particular, the instant stabilizing ligand significantly improves photo lifetime stability when dispersed in the polymeric thiol-ene matrix. The combination of the present stabilizing ligand with the quantum dot composite in thiol-ene matrix may delay the quantum dot particles from photo-degradation.

The stabilizing ligands of Formula I are prepared as Michael adducts of an aminosilicone and a (meth)acrylate ester. The aminosilicone ligand starting material has the following Formula II:

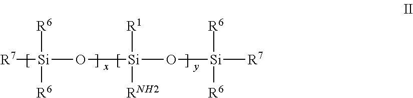

wherein
each R⁶ is independently an alkyl or aryl;
R^{NH2} is a n amine-substituted (hetero)hydrocarbyl group;
x is 1 to 2000; preferably 3 to 100;
y may be zero;
x+y is at least one;
R⁷ is alkyl, aryl or R^{NH2}
wherein amine-functional silicone has at least two R^{NH2} groups. All or part of the amino groups of the aminosilicone of Formula II undergoes 1,4-Michael addition to the (meth)acrylates. Mixture of aminosilicone ligand of Formulas I and II may be used.

Useful amino-silicones, and method of making the same, are described in US 2013/0345458 (Freeman et al.), incorporated herein by reference. Useful amine-functional silicones are described in Lubkowsha et al., Aminoalkyl Functionalized Siloxanes, Polimery, 2014 59, pp 763-768, and are available from Gelest Inc, Morrisville, Pa., from Dow Corning under the Xiameter™, including Xiameter OFX-0479, OFX-8040, OFX-8166, OFX-8220, OFX-8417, OFX-8630, OFX-8803, and OFX-8822. Useful amine-functional silicones are also available from Siletech.com under the tradenames Silamine™, and from Momentive.com under the tradenames ASF3830, SF4901, Magnasoft, Magnasoft PlusTSF4709, Baysilone OF-TP3309, RPS-116, XF40-C3029 and TSF4707.

A number of aminosilicones has been disclosed in U.S. Pat. No. 8,283,412 as a ligand for core/shell semiconductor nanocrystals, and may be used as starting materials for the ligand of Formula I.

The ligands (aminosilicones) of Formula I are the partial Michael-addition product of the aminosilicones and (meth)acrylate esters. That is, a fraction of the amine groups of the aminosilicone of Formula II undergoes Michael addition with (meth)acrylates. Useful (meth)acrylate esters are monomeric (meth)acrylic ester of an C₁-C₂₀ alkyl or aryl alcohol alcohol and poly(meth)acrylate esters, such as di-, tri- and tetra-(meth)acrylates. Acrylate esters are preferred for the greater reactivity in Michael addition reactions with amine nucleophiles.

Examples of (meth)acrylate ester monomer suitable for use as the Michael acceptor include the esters of either acrylic acid or methacrylic acid alcohols such as ethanol, 1-propanol, 2-propanol, 1-butanol, 2-butanol, 1-pentanol, 2-pentanol, 3-pentanol, 2-methyl-1-butanol, 3-methyl-1-butanol, 1-hexanol, 2-hexanol, 2-methyl-1-pentanol, 3-methyl-1-pentanol, 2-ethyl-1-butanol, 3,5,5-trimethyl-1-hexanol, 3-heptanol, 1-octanol, 2-octanol, isooctylalcohol, 2-ethyl-1-hexanol, 1-decanol, 2-propylheptanol, 1-dodecanol, 1-tridecanol, 1-tetradecanol, citronellol, dihydrocitronellol, isobornyl alcohol and the like. Representative examples of suitable aromatic alcohols include phenols such as phenol, cardinol, m-cresol, 2-methyl-5-isopropylphenol (carvacrol), 3-methyl-6-tert-butylphenol, 2,4-dimethyl-6-tert-butyl phenol, guaiacol, 2-phenoxyethanol, m-, o-, and p-chlorophenol. Acrylate esters are preferred over methacrylate esters for the Michael addition due to the higher reactivity.

Useful poly(meth)acrylate esters include, but are not limited to, di(meth)acrylates, tri(meth)acrylates, and tetra(meth)acrylates, Useful tri(meth)acrylates include, for example, trimethylolpropane tri(meth)acrylate, propoxylated trimethylolpropane triacrylates, ethoxylated trimethylolpropane triacrylates, tris(2-hydroxy ethyl)isocyanurate triacrylate, and pentaerythritol triacrylate. Useful di(meth)acrylates include, for example, ethylene glycol di(meth)acrylate, diethylene glycol di(meth)acrylate, triethylene glycol di(meth)acrylate, tetraethylene glycol di(meth)acrylate, 1,4-butanediol di(meth)acrylate, 1,6-hexanediol di(meth)acrylate, alkoxylated 1,6-hexanediol diacrylate, tripropylene glycol diacrylate, dipropylene glycol diacrylate, cyclohexane dimethanol di(meth)acrylate, alkoxylated cyclohexane dimethanol diacrylates, ethoxylated bisphenol A di(meth)acrylates, neopentyl glycol diacrylate, polyethylene glycol di(meth)acrylates, polypropylene glycol di(meth)acrylates, and urethane di(meth)acrylates.

In some preferred embodiments, the (meth)acrylate ester may be selected form silyl-functional (meth)acrylate esters. With reference to Formula I, R21 may be designated as R^{Silyl}.

Useful silane monomers include, for example, 3-(meth)acryloyloxypropyltrimethylsilane, 3-(meth)acryloyloxypropyltriethylsilane, 3-(meth)acryloyloxypropylmethyldimethylsilane, 3-(methacryloyloxy)propyldimethylethylsilane, 3-(meth)acryloyloxypropyldiethylethylsilane, 3-(methacryloyloxy)propyl-tris-trimethylsilyl silane and mixtures thereof.

In other useful embodiments, the silane-functional monomer may be selected from silane functional macromers, such as those disclosed in US 2007/0054133 (Sherman et al.) and US 2013/0224373 (Jariwala et al.), incorporated herein by reference and those silicone macromers obtained from Gelest, such as methacryloxypropyl terminated polydimethylsiloxanes.

The preparation of silane macromonomer and subsequent co-polymerization with vinyl monomer have been described in several papers by Y. Yamashita et al., Polymer J. 14, 913 (1982); ACS Polymer Preprints 25 (1), 245 (1984); Makromol. Chem. 185, 9 (1984), and in U.S. Pat. Nos. 3,786,116 and 3,842,059 (Milkovich et al.).

Although no catalyst is generally required for the Michael addition of the aminosilanes to the acryloyl groups, suitable catalysts for the Michael reaction is a base of which the conjugated acid preferably has a pKa between 12 and 14. Most preferably used bases are organic. Examples of such bases are 1,4-dihydropyridines, methyl diphenylphosphane, methyl di-p-tolylphosphane, 2-allyl-N-alkyl imidazolines, tetra-t-butylammonium hydroxide, DBU (1,8-diazabicyclo[5.4.0]undec-7-ene) and DBN (1,5-diazabicyclo[4.3.0]non-5-ene), potassium methoxide, sodium methoxide, sodium hydroxide, and the like. A preferred catalyst in connection with this invention is DBU and tetramethylguanidine. The amount of catalyst used in the Michael addition reaction is preferably between 0.05% by weight and 2% by weight more preferably between 0.1% by weight and 1.0% by weight, relative to solids.

The (meth)acrylate monomer is used in amounts such that the 20 to 90% of the amino groups of the aminosilicone of Formula 2 undergo Michael addition to a (meth)acrylate to produce the aminosilicone of Formula I. With reference to Formula I, the ratio of subscripts y to z is 4:1 to 1:9.

The quantum dots are stabilized with the aminosilicone of Formula I. In addition, the quantum dots may be further stabilized with the combined aminosilicone of Formula II and modified aminosilicone of Formula I. In such instances the weight ratio of the aminosilicone of Formula II may be in 10 to 60%, relative to the amount of Formula I.

Aminosilicone ligand stabilized quantum dots in thiol-ene matrix has been described in Applicant's copending U.S. Ser. No. 62/195,434 (WO2016/081219), which demonstrated great barrier properties with extremely low edge ingress, but also further enhanced quantum yield. In those compositions the estimated photo lifetime stability is about 17,000 hours from a series of accelerated tests under high intensity light test (HILT, ˜10× blue light intensity) or super high intensity light (SHILT, ˜10× blue light intensity) conditions. In comparison, the instant ligands of Formula I further improve the photo lifetime stability for broader application, such as TV.

The composite particles comprising the fluorescent core-shell nanoparticles, ligand modified by the silicone ligand of Formula I, and other optional ligands are dispersed in the high refractive index thiol-ene resin. More particular the core-shell quantum dots modified by aminosilicone ligand of Formula I form a liquid quantum dot composite, which may be dispersed in the form of droplets in the thiol-ene resin on mixing, and subsequently cured.

As described, the composite particles comprise the fluorescent nanoparticles and the aminosilicone of Formula I, derived from Michael-addition of (meth)acrylate esters to the aminosilicone of Formula II. In some embodiments, the aminosilicone of Formula I is separately prepared and combined with the fluorescent nanoparticles to form the composite particles. In other embodiments the aminosilicone of Formula I is generated in situ by combining the fluorescent nanoparticles stabilized by the aminosilicone ligand of Formula II and the (meth)acrylate ester to form the fluorescent nanoparticles stabilized by the aminonosilicone ligand of Formula I. For example, the fluorescent nanoparticles, the aminosilicone of Formula II and the (meth)acrylate ester can be combined to undergo the Michael addition in situ, and dispersed in the thiol-ene resin. Alternatively, the fluorescent nanoparticles ligand-stabilized by the aminosilicone ligand of Formula II can be combined and then dispersed in a second component of thiol-ene resin and the (meth)acrylate ester, which again will form the aminosilicone ligand of Formula I in situ.

In these embodiment, the following quantum dot composite coating compositions are provided:
1. A quantum dot composite coating composition comprising:
   a) quantum dots stabilized with an aminosilicone ligand of Formula I; and
   b) a thiol-ene resin;
      wherein the weight ratio of the liquid quantum dot composite to thiol-ene resin is from 1:99 to 20:80, and the preferred esters are selected from acrylate esters. The ligand-functionalized quantum dots form a dispersion of droplets in the thiol-ene resin (or cured matrix).
2. A quantum dot coating composition comprising;
   a) a first component comprising a quantum dot composite comprising fluorescent nanoparticles stabilized with a aminosilicone ligand of Formula II and a (meth)acrylate ester; and
   b) a second component comprising a thiol-ene resin;
      wherein the weight ratio of (meth)acrylate to quantum dot composite is from 5:95 to 80:20, and the preferred (meth)acrylate ester in the first component is acrylate ester.
3. A quantum dot coating composition comprising;
   a) a first component comprising quantum dot composite comprising fluorescent nanoparticles stabilized with a aminosilicone carrier of Formula II; and
   b) a second component comprising a thiol-ene resin and a (meth)acrylate ester;
      wherein the weight ratio of (meth)acrylate ester to ene of the thiol-ene resin in the second component is from 5:95 to 50:50 preferably 10:90 to 30:70

In each of these compositions, the (meth)acrylate may be a mono- or polyfunctional (meth)acrylate.

The present disclosure further provides a quantum dot film article comprising a first barrier layer, a second barrier layer; and a quantum dot layer between the first barrier layer and the second barrier layer, the quantum dot layer comprising fluorescent core-shell nanoparticles ligand functionalized by the aminosilicone of Formula I (quantum dots) dispersed in a matrix comprising a cured thiol-ene matrix.

The cured thiol-ene matrix or binder is the reaction product of a polythiol compound a polyene compound (thiol-ene resin) wherein both have a functionality of ≥2. Preferably at least one of the polythiol compound and polyene compound has a functionality of >2.

The polythiol reactant in the thiol-ene resin is of the formula:

R²(SH)_{w}, V

where R² is (hetero)hydrocarbyl group having a valence of w, and w is ≥2, preferably >2. The thiol groups of the polythiols may be primary or secondary. The compounds of Formula I may include a mixture of compounds having an average functionality of two or greater.

R² includes any (hetero)hydrocarbyl groups, including aliphatic and aromatic polythiols. R² may optionally further include one or more functional groups including pendent hydroxyl, acid, ester, or cyano groups or catenary (in-chain) ether, urea, urethane and ester groups.

In one embodiment, R² comprises a non-polymeric aliphatic or cycloaliphatic moiety having from 1 to 30 carbon atoms. In another embodiment, R² is polymeric and comprises a polyoxyalkylene, polyester, polyolefin, polyacrylate, or polysiloxane polymer having pendent or terminal reactive —SH groups. Useful polymers include, for example, thiol-terminated polyethylenes or polypropylenes, and thiol-terminated poly(alkylene oxides).

Specific examples of useful polythiols include 2,3-dimercapto-1-propanol, 2-mercaptoethyl ether, 2-mercaptoethyl sulfide, 1,6-hexanedithiol, 1,8-octanedithiol, 1,8-dimercapto-3,6-dithiaoctane, propane-1,2,3-trithiol, and trithiocyanuric acid.

Another useful class of polythiols includes those obtained by esterification of a polyol with a terminally thiol-substituted carboxylic acid (or derivative thereof, such as esters or acyl halides) including α- or β-mercaptocarboxylic acids such as thioglycolic acid, β-mercaptopropionic acid, 2-mercaptobutyric acid, or esters thereof.

Useful examples of commercially available compounds thus obtained include ethylene glycol bis(thioglycolate), pentaerythritol tetrakis(3-mercaptopropionate), dipentaerythritol hexakis(3-mercaptopropionate), ethylene glycol bis(3-mercaptopropionate), trimethylolpropane tris(thioglycolate), trimethylolpropane tris(3-mercaptopropionate), pentaerythritol tetrakis(thioglycolate), pentaerythritol tetrakis(3-mercaptopropionate), pentaerithrytol tetrakis (3-mercaptobutylate), and 1,4-bis 3-mercaptobutylyloxy butane, tris[2-(3-mercaptopropionyloxy]ethyl]isocyanurate, trimethylolpropane tris(mercaptoacetate), 2,4-bis(mercaptomethyl)-1,3,5,-triazine-2,4-dithiol, 2,3-di(2-mercaptoethyl)thio)-1-propanethiol, dimercaptodiethylsufide, and ethoxylated trimethylpropan-tri(3-mercaptopropionate.

A specific example of a polymeric polythiol is polypropylene ether glycol bis(3-mercaptopropionate) which is prepared by esterification of polypropylene-ether glycol (e.g., Pluracol™ P201, BASF Wyandotte Chemical Corp.) and 3-mercaptopropionic acid by esterification.

Useful soluble, high molecular weight thiols include polyethylene glycol di(2-mercaptoacetate), LP-3™ resins supplied by Morton Thiokol Inc. (Trenton, N.J.), and Permapol P3™ resins supplied by Products Research & Chemical Corp. (Glendale, Calif.) and compounds such as the adduct of 2-mercaptoethylamine and caprolactam.

The curable composition contains a polyene compound having at least two reactive ene groups including alkenyl and alkynyl groups. Such compounds are of the general formula:

R¹CR¹⁰═CHR¹¹]ₓ, VIa

or

R¹C≡C—R¹¹]ₓ VIb

where
R¹ is a polyvalent (hetero)hydrocarbyl group,
each of R¹⁰ and R¹¹ are independently H or C₁-C₄ alkyl;
and x is ≥2. The compounds of Formula VIa may include vinyl ethers.

In some embodiments, R¹ is an aliphatic or aromatic group. R¹ can be selected from alkyl groups of 1 to 20 carbon atoms or aryl aromatic group containing 6-18 ring atoms. R² has a valence of x, where x is at least 2, preferably greater than 2. R¹ optionally contains one or more esters, amide, ether, thioether, urethane, or urea functional groups. The compounds of Formula I may include a mixture of compounds having an average functionality of two or greater. In some embodiments, R¹⁰ and R¹¹ may be taken together to form a ring.

In some embodiments, R¹ is a heterocyclic group. Heterocyclic groups include both aromatic and non-aromatic ring systems that contain one or more nitrogen, oxygen and sulfur heteroatoms. Suitable heteroaryl groups include furyl, thienyl, pyridyl, quinolinyl, tetrazolyl, imidazo, and triazinyl. The heterocyclic groups can be unsubstituted or substituted by one or more substituents selected from the group consisting of alkyl, alkoxy, alkylthio, hydroxy, halogen, haloalkyl, polyhaloalkyl, perhaloalkyl (e.g., trifluoromethyl), trifluoroalkoxy (e.g., trifluoromethoxy), nitro, amino, alkylamino, dialkylamino, alkylcarbonyl, alkenylcarbonyl, arylcarbonyl, heteroarylcarbonyl, aryl, arylalkyl, heteroaryl, heteroarylalkyl, heterocyclyl, heterocycloalkyl, nitrile and alkoxycarbonyl.

In some embodiments, the alkene compound is the reaction product of a mono- or polyisocyanate:

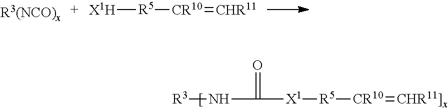

where
R³ is a (hetero)hydrocarbyl group;
X¹ is —O—, —S— or —NR⁴—, where R⁴ is H of C₁-C₄ alkyl;
each of R¹⁰ and R¹¹ are independently H or C₁-C₄ alkyl;
R⁵ is a (hetero)hydrocarbyl group,
x is ≥2.

In particular R⁵ may be alkylene, arylene, alkarylene, aralkylene, with optional in-chain heteroatoms. R⁵ can be selected from alkyl groups of 1 to 20 carbon atoms or aryl aromatic group containing 6-18 ring atoms. R² has a valence of x, where x is at least 2, preferably greater than 2. R¹ optionally contains one or more ester, amide, ether, thioether, urethane, or urea functional groups.

Polyisocyanate compounds useful in preparing the alkene compounds comprise isocyanate groups attached to the multivalent organic group that can comprise, in some embodiments, a multivalent aliphatic, alicyclic, or aromatic moiety (R³); or a multivalent aliphatic, alicyclic or aromatic moiety attached to a biuret, an isocyanurate, or a uretdione, or mixtures thereof. Preferred polyfunctional isocyanate compounds contain at least two isocyanate (—NCO) radicals. Compounds containing at least two —NCO radicals are preferably comprised of di- or trivalent aliphatic, alicyclic, aralkyl, or aromatic groups to which the —NCO radicals are attached.

Representative examples of suitable polyisocyanate compounds include isocyanate functional derivatives of the polyisocyanate compounds as defined herein. Examples of derivatives include, but are not limited to, those selected from the group consisting of ureas, biurets, allophanates, dimers and trimers (such as uretdiones and isocyanurates) of isocyanate compounds, and mixtures thereof. Any suitable organic polyisocyanate, such as an aliphatic, alicyclic, aralkyl, or aromatic polyisocyanate, may be used either singly or in mixtures of two or more.

The aliphatic polyisocyanate compounds generally provide better light stability than the aromatic compounds. Aromatic polyisocyanate compounds, on the other hand, are generally more economical and reactive toward nucleophiles than are aliphatic polyisocyanate compounds. Suitable aromatic polyisocyanate compounds include, but are not limited to, those selected from the group consisting of 2,4-toluene diisocyanate (TDI), 2,6-toluene diisocyanate, an adduct of TDI with trimethylolpropane (available as Desmodur™ CB from Bayer Corporation, Pittsburgh, Pa.), the isocyanurate trimer of TDI (available as Desmodur™ IL from Bayer Corporation, Pittsburgh, Pa.), diphenylmethane 4,4′-diisocyanate (MDI), diphenylmethane 2,4′-diisocyanate, 1,5-diisocyanato-naphthalene, 1,4-phenylene diisocyanate, 1,3-phenylene diisocyanate, 1-methyoxy-2,4-phenylene diisocyanate, 1-chlorophenyl-2,4-diisocyanate, and mixtures thereof.

Examples of useful alicyclic polyisocyanate compounds include, but are not limited to, those selected from the group consisting of dicyclohexylmethane diisocyanate (H₁₂ MDI, commercially available as Desmodur™ available from Bayer Corporation, Pittsburgh, Pa.), 4,4′-isopropyl-bis(cyclohexylisocyanate), isophorone diisocyanate (IPDI), cyclobutane-1,3-diisocyanate, cyclohexane 1,3-diisocyanate, cyclohexane 1,4-diisocyanate (CHDI), 1,4-cyclohexanebis(methylene isocyanate) (BDI), dimer acid diisocyanate (available from Bayer), 1,3-bis(isocyanatomethyl)cyclohexane (H₆ XDI), 3-isocyanatomethyl-3,5,5-trimethylcyclohexyl isocyanate, and mixtures thereof.

Examples of useful aliphatic polyisocyanate compounds include, but are not limited to, those selected from the group consisting of tetramethylene 1,4-diisocyanate, hexamethylene 1,4-diisocyanate, hexamethylene 1,6-diisocyanate (HDI), octamethylene 1,8-diisocyanate, 1,12-diisocyanatododecane, 2,2,4-trimethyl-hexamethylene diisocyanate (TMDI), 2-methyl-1,5-pentamethylene diisocyanate, dimer diisocyanate, the urea of hexamethylene diisocyanate, the biuret of hexamethylene 1,6-diisocyanate (HDI) (Desmodur™ N-100 and N-3200 from Bayer Corporation, Pittsburgh, Pa.), the isocyanurate of HDI (available as Desmodur™ N-3300 and Desmodur™ N-3600 from Bayer Corporation, Pittsburgh, Pa.), a blend of the isocyanurate of HDI and the uretdione of HDI (available as Desmodur™ N-3400 available from Bayer Corporation, Pittsburgh, Pa.), and mixtures thereof.

Examples of useful aralkyl polyisocyanates (having alkyl substituted aryl groups) include, but are not limited to, those selected from the group consisting of m-tetramethyl xylylene diisocyanate (m-TMXDI), p-tetramethyl xylylene diisocyanate (p-TMXDI), 1,4-xylylene diisocyanate (XDI), 1,3-xylylene diisocyanate, p-(1-isocyanatoethyl)phenyl isocyanate, m-(3-isocyanatobutyl)phenyl isocyanate, 4-(2-isocyanatocyclohexyl-methyl)phenyl isocyanate, and mixtures thereof.

Preferred polyisocyanates, in general, include those selected from the group consisting of 2,2,4-trimethyl-hexamethylene diisocyanate (TMDI), tetramethylene 1,4-diisocyanate, hexamethylene 1,4-diisocyanate, hexamethylene 1,6-diisocyanate (HDI), octamethylene 1,8-diisocyanate, 1,12-diisocyanatododecane, mixtures thereof, and a biuret, an isocyanurate, or a uretdione derivatives.

In some preferred embodiments, the alkene compound is a cyanurate or isocyanurate of the formulas:

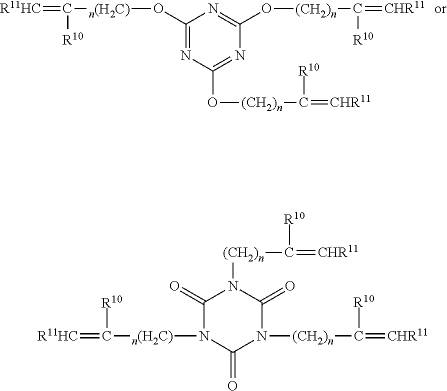

where n is at least one;
each of R¹⁰ and R¹¹ are independently H or C₁-C₄ alkyl.

The polyene compounds may be prepared as the reaction product of a polythiol compound and an epoxy-alkene compound. Similarly, the polyene compound may be prepared by reaction of a polythiol with a di- or higher epoxy compound, followed by reaction with an epoxy-alkene compound. Alternatively, a polyamino compound may be reacted with an epoxy-alkene compound, or a polyamino compound may be reacted a di- or higher epoxy compound, followed by reaction with an epoxy-alkene compound.

The polyene may be prepared by reaction of a bis-alkenyl amine, such a HN(CH₂CH═CH₂), with either a di- or higher epoxy compound, or with a bis- or high (meth)acrylate, or a polyisocyanate.

The polyene may be prepared by reaction of a hydroxy-functional polyalkenyl compound, such as (CH₂═CH—CH₂—O)ₙ—R—OH with a polyepoxy compound or a polyisocyanate.

An oligomeric polyene may be prepared by reaction between a hydroxyalkyl (meth)acrylate and an allyl glycidyl ether.

In some preferred embodiments, the polyene and/or the polythiol compounds are oligomeric and prepared by reaction of the two with one in excess. For example, polythiols of Formula V may be reacted with an excess of polyenes of Formulas VI a,b such that an oligomeric polyene results having a functionality of at least two. Conversely an excess of polythiols of Formula V may be reacted with the polyenes of Formula VI a,b such that an oligomeric polythiol results having a functionality of at least two. The oligomeric polyenes and polythiols may be represented by the following formulas, where subscript z is two or greater. R¹, R², R¹⁰, R¹¹, y and x are as previously defined.

In the following formulas, a linear thiol-ene polymer is shown for simplicity. It will be understood that the pendent ene group of the first polymer will have reacted with the excess thiol, and the pendent thiol groups of the second polymer will have reacted with the excess alkene. It will be understood that the corresponding alkynyl compounds may be used.

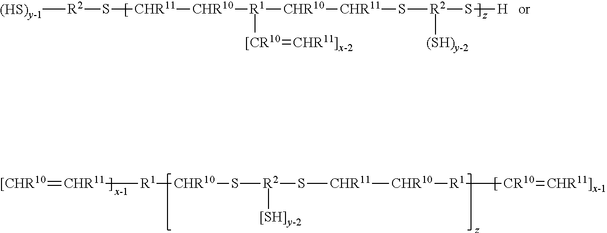

In some embodiments (meth)acrylates are used in the matrix binder composition. In some embodiments, a radiation curable methacrylate compound can increase the viscosity of the matrix composition and can reduce defects that would otherwise be created during the thermal acceleration of the thiol-ene resin. Useful radiation curable methacrylate compounds have barrier properties to minimize the ingress of water and/or oxygen. In some embodiments, methacrylate compounds with a glass transition temperature (T_{g}) of greater than about 100° C. and substituents capable of forming high crosslink densities can provide a matrix with improved gas and water vapor barrier properties. In some embodiments, the radiation curable methacrylate compound is multifunctional, and suitable examples include, but are not limited to, those available under the trade designations SR 348 (ethoxylated (2) bisphenol A di(meth)acrylate), SR540 (ethoxylated (4) bisphenol A di(meth)acrylate), and SR239 (1,6-hexane diol di(meth)acrylate) from Sartomer USA, LLC, Exton, Pa.

The (meth)acrylate compound forms about 0 wt % to about 25 wt %, or about 5 wt % to about 25 wt % or about 10 wt % to about 20 wt %, of the matrix composition. In some embodiments, if the methacrylate polymer forms less than 5 wt % of the matrix composition, the (meth)acrylate compound does not adequately increase the viscosity of the matrix composition to provide the thiol-ene composition with a sufficient working time.

The components are generally used in approximately 1:1 molar amounts of thiol groups to ene groups, +/−20%. Therefore, the molar ratio of thiol groups of the polythiol to ene groups of the polyene will be from 1.2:1 to 1:1.2, preferably 1.1:1 to 1:1.1. In embodiments where the thiol-ene polymer composition further comprises an (meth)acrylate component, the molar functional group equivalent of alkene plus the molar functional group equivalent of (meth)acrylate is equal to the thiol equivalents +/−20%.

The thiol-ene resin may be prepared by combining the polythiol and polyene in suitable rations and then free-radically cured using a photo, thermal or redox initiator.

The thiol-ene resin may be cured by exposure to actinic radiation such as UV light. The composition may be exposed to any form of actinic radiation, such as visible light or UV radiation, but is preferably exposed to UVA (320 to 390 nm) or UVV (395 to 445 nm) radiation. Generally, the amount of actinic radiation should be sufficient to form a solid mass that is not sticky to the touch. Generally, the amount of energy required for curing the compositions of the invention ranges from about 0.2 to 20.0 J/cm².

To initiate photopolymerization, the resin is placed under a source of actinic radiation such as a high-energy ultraviolet source having a duration and intensity of such exposure to provide for essentially complete (greater than 80%) polymerization of the composition contained in the molds. If desired, filters may be employed to exclude wavelengths that may deleteriously affect the reactive components or the photopolymerization. Photopolymerization may be affected via an exposed surface of the curable composition, or through the barrier layers as described herein by appropriate selection of a barrier film having the requisite transmission at the wavelengths necessary to effect polymerization.

Photoinitiation energy sources emit actinic radiation, i.e., radiation having a wavelength of 700 nanometers or less which is capable of producing, either directly or indirectly, free radicals capable of initiating polymerization of the thiol-ene compositions. Preferred photoinitiation energy sources emit ultraviolet radiation, i.e., radiation having a wavelength between about 180 and 460 nanometers, including photoinitiation energy sources such as mercury arc lights, carbon arc lights, low, medium, or high pressure mercury vapor lamps, swirl-flow plasma arc lamps, xenon flash lamps ultraviolet light emitting diodes, and ultraviolet light emitting lasers. Particularly preferred ultraviolet light sources are ultraviolet light emitting diodes available from Nichia Corp., Tokyo Japan, such as models NVSU233A U385, NVSU233A U404, NCSU276A U405, and NCSU276A U385.

In one embodiment, the initiator is a photoinitiator and is capable of being activated by UV radiation. Useful photoinitiators include e.g., benzoin ethers such as benzoin methyl ether and benzoin isopropyl ether, substituted benzoin ethers, substituted acetophenones such as 2,2-dimethoxy-2-phenylacetophenone, and substituted alpha-ketols. Examples of commercially available photoinitiators include Irgacure™ 819 and Darocur™ 1173 (both available form Ciba-Geigy Corp., Hawthorne, N.Y.), Lucem TPO™ (available from BASF, Parsippany, N.J.) and Irgacure™ 651, (2,2-dimethoxy-1,2-diphenyl-1-ethanone) which is available from Ciba-Geigy Corp. Preferred photoinitiators are ethyl 2,4,6-trimethylbenzoylphenyl phosphinate (Lucirin™ TPO-L) available from BASF, Mt. Olive, N.J., 2-hydroxy-2-methyl-1-phenyl-propan-1-one (IRGACURE 1173, Ciba Specialties), 2,2-dimethoxy-2-phenyl acetophenone (IRGACURE 651™, Ciba Specialties), phenyl bis(2,4,6-trimethyl benzoyl)phosphine oxide (IRGACURE 819, Ciba Specialties). Other suitable photoinitiators include mercaptobenzothiazoles, mercaptobenzooxazoles and hexaryl bisimidazole.

Examples of suitable thermal initiators include peroxides such as benzoyl peroxide, dibenzoyl peroxide, dilauryl peroxide, cyclohexane peroxide, methyl ethyl ketone peroxide, hydroperoxides, e.g., tert-butyl hydroperoxide and cumene hydroperoxide, dicyclohexyl peroxydicarbonate, 2,2,-azo-bis(isobutyronitrile), and t-butyl perbenzoate. Examples of commercially available thermal initiators include initiators available from DuPont Specialty Chemical (Wilmington, Del.) under the VAZO trade designation including VAZO™ 64 (2,2′-azo-bis(isobutyronitrile)) and VAZO™ 52, and Lucidol™ 70 from Elf Atochem North America, Philadelphia, Pa.

The thiol-ene resins may also be polymerized using a redox initiator system of an organic peroxide and a tertiary amine. Reference may be made to Bowman et al., Redox Initiation of Bulk Thiol-alkene Polymerizations, Polym. Chem., 2013, 4, 1167-1175, and references therein.

Generally, the amount of initiator is less than 5 wt. %, preferably less than 2 wt. %. In some embodiments, there is no added free radical initiator.

If desired, a stabilizer or inhibitor may be added to the thiol-ene composition to control the rate of reaction. The stabilizer can be any known in the art of thiol-ene resins and include the N-nitroso compounds described in U.S. Pat. No. 5,358,976 (Dowling et al.) and in U.S. Pat. No. 5,208,281 (Glaser et al.), and the alkenyl substituted phenolic compounds described in U.S. Pat. No. 5,459,173 (Glaser et al.).

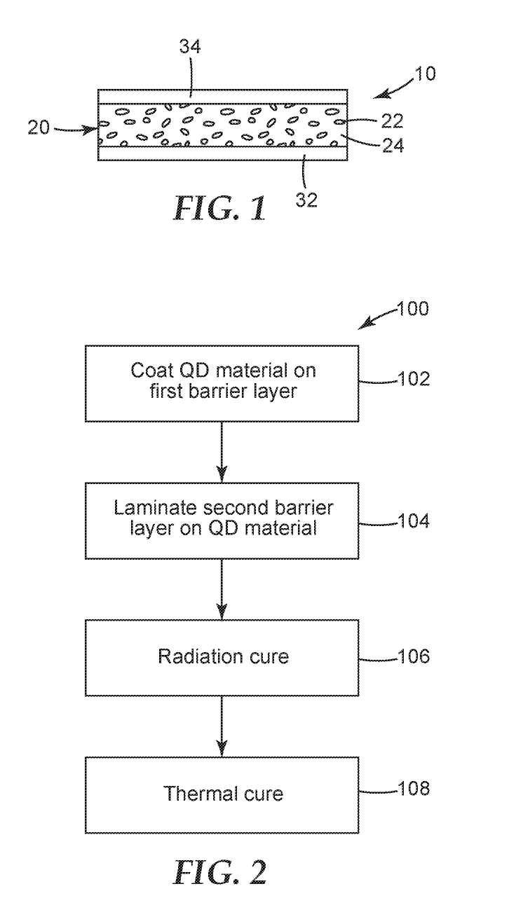

Referring to FIG. 1, quantum dot article 10 includes a first barrier layer 32, a second barrier layer 34, and a quantum dot layer 20 between the first barrier layer 32 and the second barrier layer 34. The quantum dot layer 20 includes a plurality of quantum dots 22 dispersed in a matrix 24.

The barrier layers 32, 34 can be formed of any useful material that can protect the quantum dots 22 from exposure to environmental contaminates such as, for example, oxygen, water, and water vapor. Suitable barrier layers 32, 34 include, but are not limited to, films of polymers, glass and dielectric materials. In some embodiments, suitable materials for the barrier layers 32, 34 include, for example, polymers such as polyethylene terephthalate (PET); oxides such as silicon oxide, titanium oxide, or aluminum oxide (e.g., SiO₂, Si₂O₃, TiO₂, or Al₂O₃); and suitable combinations thereof.

More particularly, barrier films can be selected from a variety of constructions. Barrier films are typically selected such that they have oxygen and water transmission rates at a specified level as required by the application. In some embodiments, the barrier film has a water vapor transmission rate (WVTR) less than about 0.005 g/m²/day at 38° C. and 100% relative humidity; in some embodiments, less than about 0.0005 g/m²/day at 38° C. and 100% relative humidity; and in some embodiments, less than about 0.00005 g/m²/day at 38° C. and 100% relative humidity. In some embodiments, the flexible barrier film has a WVTR of less than about 0.05, 0.005, 0.0005, or 0.00005 g/m²/day at 50° C. and 100% relative humidity or even less than about 0.005, 0.0005, 0.00005 g/m²/day at 85° C. and 100% relative humidity. In some embodiments, the barrier film has an oxygen transmission rate of less than about 0.005 g/m²/day at 23° C. and 90% relative humidity; in some embodiments, less than about 0.0005 g/m²/day at 23° C. and 90% relative humidity; and in some embodiments, less than about 0.00005 g/m²/day at 23° C. and 90% relative humidity.

Exemplary useful barrier films include inorganic films prepared by atomic layer deposition, thermal evaporation, sputtering, and chemical vapor deposition. Useful barrier films are typically flexible and transparent. In some embodiments, useful barrier films comprise inorganic/organic. Flexible ultra-barrier films comprising inorganic/organic multilayers are described, for example, in U.S. Pat. No. 7,018,713 (Padiyath et al.). Such flexible ultra-barrier films may have a first polymer layer disposed on polymeric film substrate that is overcoated with two or more inorganic barrier layers separated by at least one second polymer layer. In some embodiments, the barrier film comprises one inorganic barrier layer interposed between the first polymer layer disposed on the polymeric film substrate and a second polymer layer 224.

In some embodiments, each barrier layer 32, 34 of the quantum dot article 10 includes at least two sub-layers of different materials or compositions. In some embodiments, such a multi-layered barrier construction can more effectively reduce or eliminate pinhole defect alignment in the barrier layers 32, 34, providing a more effective shield against oxygen and moisture penetration into the matrix 24. The quantum dot article 10 can include any suitable material or combination of barrier materials and any suitable number of barrier layers or sub-layers on either or both sides of the quantum dot layer 20. The materials, thickness, and number of barrier layers and sub-layers will depend on the particular application, and will suitably be chosen to maximize barrier protection and brightness of the quantum dots 22 while minimizing the thickness of the quantum dot article 10. In some embodiments each barrier layer 32, 34 is itself a laminate film, such as a dual laminate film, where each barrier film layer is sufficiently thick to eliminate wrinkling in roll-to-roll or laminate manufacturing processes. In one illustrative embodiment, the barrier layers 32, 34 are polyester films (e.g., PET) having an oxide layer on an exposed surface thereof.

The quantum dot layer 20 can include one or more populations of quantum dots or quantum dot materials 22. Exemplary quantum dots or quantum dot materials 22 emit green light and red light upon down-conversion of blue primary light from a blue LED to secondary light emitted by the quantum dots. The respective portions of red, green, and blue light can be controlled to achieve a desired white point for the white light emitted by a display device incorporating the quantum dot article 10. Exemplary quantum dots 22 for use in the quantum dot articles 10 include, but are not limited to, InP or CdSe with ZnS shells. Suitable quantum dots for use in quantum dot articles described herein include, but are not limited to, core/shell luminescent nanocrystals including CdSe/ZnS, InP/ZnS, PbSe/PbS, CdSe/CdS, CdTe/CdS or CdTe/ZnS. In exemplary embodiments, the luminescent nanocrystals include an outer ligand coating and are dispersed in a polymeric matrix. Quantum dot and quantum dot materials 22 are commercially available from, for example, Nanosys Inc., Milpitas, Calif. The quantum dot layer 20 can have any useful amount of quantum dots 22, and in some embodiments the quantum dot layer 20 can include from 0.1 wt % to 1 wt % quantum dots, based on the total weight of the quantum dot layer 20.

In one or more embodiments the quantum dot layer 20 can optionally include scattering beads or particles. These scattering beads or particles have a refractive index that differs from the refractive index of the matrix material 24 by at least 0.05, or by at least 0.1. These scattering beads or particles can include, for example, polymers such as silicone, acrylic, nylon, and the like, or inorganic materials such as TiO₂, SiOₓ, AlOₓ, and the like, and combinations thereof. In some embodiments, including scattering particles in the quantum dot layer 20 can increase the optical path length through the quantum dot layer 20 and improve quantum dot absorption and efficiency. In many embodiments, the scattering beads or particles have an average particle size from 1 to 10 micrometers, or from 2 to 6 micrometers. In some embodiments, the quantum dot material 20 can optionally include fillers such fumed silica.

In some preferred embodiments, the scattering beads or particles are Tospearl™ 120A, 130A, 145A and 2000B spherical silicone resins available in 2.0, 3.0, 4.5 and 6.0 micron particle sizes respectively from Momentive Specialty Chemicals Inc., Columbus, Ohio.

The matrix 24 of the quantum dot layer 20 can be formed from a polymeric binder or binder precursor that adheres to the materials forming the barrier layers 32, 34 to form a laminate construction, and also forms a protective matrix for the quantum dots 22. In one embodiment, the matrix 24 is formed by curing or hardening an adhesive composition including an epoxy amine polymer and an optional radiation-curable methacrylate compound.

Referring to FIG. 2, in another aspect, the present disclosure is directed to a method of forming a quantum dot film article 100 including coating a composition including quantum dots on a first barrier layer 102 and disposing a second barrier layer on the quantum dot material 104. In some embodiments, the method 100 includes polymerizing (e.g., radiation curing) the radiation curable polymeric binder to form a fully- or partially cured quantum dot material 106 and optionally thermally polymerizing the binder composition to form a cured polymeric binder 108.

In some embodiments, the binder composition can be cured or hardened by heating. In other embodiments, the composition may also be cured or hardened by applying radiation such as, for example, ultraviolet (UV) light. Curing or hardening steps may include UV curing, heating, or both. In some example embodiments that are not intended to be limiting, UV cure conditions can include applying about 10 mJ/cm² to about 4000 mJ/cm² of UVA, more preferably about 10mJ/cm² to about 200 mJ/cm² of UVA. Heating and UV light may also be applied alone or in combination to increase the viscosity of the binder composition, which can allow easier handling on coating and processing lines.

In some embodiments, the binder composition may be cured after lamination between the overlying barrier films 32, 34. Thus, the increase in viscosity of the binder composition locks in the coating quality right after lamination. By curing right after coating or laminating, in some embodiments the cured binder increases in viscosity to a point that the binder composition acts to hold the laminate together during the cure and greatly reduces defects during the cure. In some embodiments, the radiation cure of the binder provides greater control over coating, curing and web handling as compared to traditional thermal curing.

Once at least partially cured, the binder composition forms polymer network that provides a protective supporting matrix 24 for the quantum dots 22.

Ingress, including edge ingress, is defined by a loss in quantum dot performance due to ingress of moisture and/or oxygen into the matrix 24. In various embodiments, the edge ingress of moisture and oxygen into the cured matrix 24 is less than about 1.25 mm after 1 week at 85° C., or about less than 0.75 mm after 1 week at 85° C., or less than about 0.5 mm after 1 week at 85° C. In various embodiments, oxygen permeation into the cured matrix is less than about 80 (cc.mil)/(m²day), or less than about 50 (cc.mil)/(m²day). In various embodiments, the water vapor transmission rate of the cured matrix should be less than about 15 (20 g/m².mil.day), or less than about 10 (20 g/m².mil.day).

In various embodiments, the thickness of the quantum dot layer 20 is about 80 microns to about 250 microns.

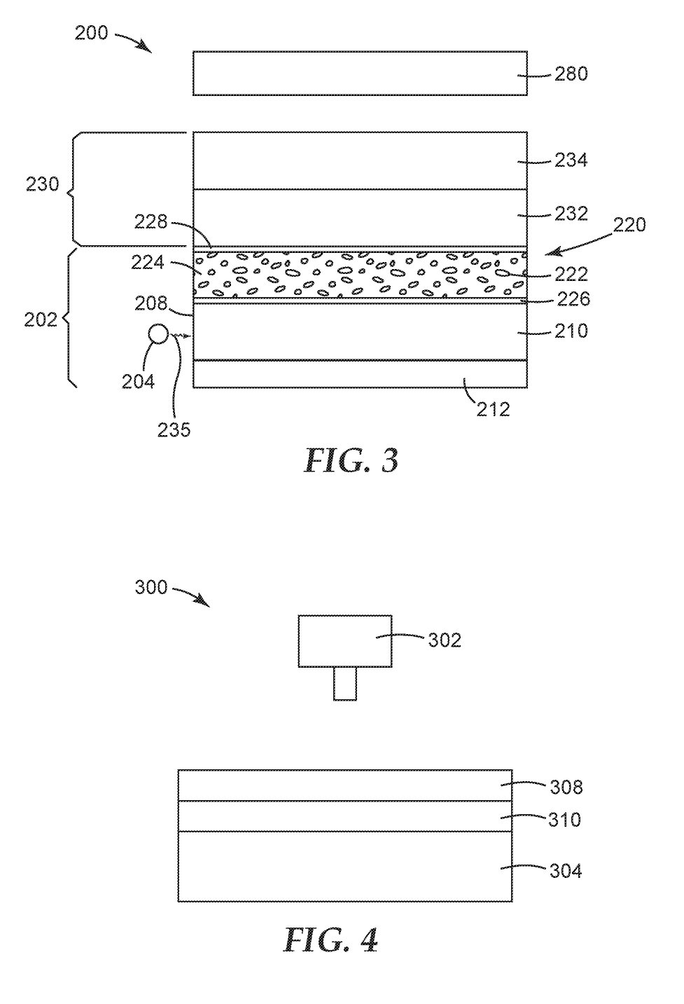

FIG. 3 is a schematic illustration of an embodiment of a display device 200 including the quantum dot articles described herein. This illustration is merely provided as an example and is not intended to be limiting. The display device 200 includes a backlight 202 with a light source 204 such as, for example, a light emitting diode (LED). The light source 204 emits light along an emission axis 235. The light source 204 (for example, a LED light source) emits light through an input edge 208 into a hollow light recycling cavity 210 having a back reflector 212 thereon. The back reflector 212 can be predominately specular, diffuse or a combination thereof, and is preferably highly reflective. The backlight 202 further includes a quantum dot article 220, which includes a protective matrix 224 having dispersed therein quantum dots 222. The protective matrix 224 is bounded on both surfaces by polymeric barrier films 226, 228, which may include a single layer or multiple layers.

The display device 200 further includes a front reflector 230 that includes multiple directional recycling films or layers, which are optical films with a surface structure that redirects off-axis light in a direction closer to the axis of the display, which can increase the amount of light propagating on-axis through the display device, this increasing the brightness and contrast of the image seen by a viewer. The front reflector 230 can also include other types of optical films such as polarizers. In one non-limiting example, the front reflector 230 can include one or more prismatic films 232 and/or gain diffusers. The prismatic films 232 may have prisms elongated along an axis, which may be oriented parallel or perpendicular to an emission axis 235 of the light source 204. In some embodiments, the prism axes of the prismatic films may be crossed. The front reflector 230 may further include one or more polarizing films 234, which may include multilayer optical polarizing films, diffusely reflecting polarizing films, and the like. The light emitted by the front reflector 230 enters a liquid crystal (LC) panel 280. Numerous examples of backlighting structures and films may be found in, for example, U.S. Pat. No. 8,848,132 (O'Neill et al.).

### EXAMPLES

Materials

| Material | Description |
|---|---|
| R-QD | Red quantum dots with amino-silicone ligands (QCEF62290R2-01), available from Nanosys |
| | Corp., Milpitas CA. |
| G-QD | Green quantum dot with amino-silicone ligands (QCEF53040R2-01), available from Nanosys |
| | Corp., Milpitas CA. |
| SR339 | 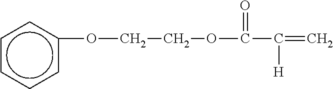 2-Phenoxyethyl acrylate, available from Sartomer, Exton, PA under trade designation “SR339” |
| SR340 | 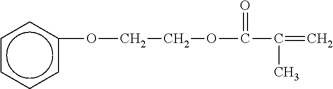 2-Phenoxyethyl methacrylate, available from Sartomer, Exton, PA under trade designation “SR340” |
| SR348 | 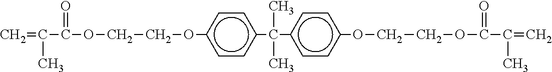 Ethoxylated (2) bisphenol A dimethacrylate, available from Sartomer, Exton, PA under trade designation “SR348”. |
| SR349 | 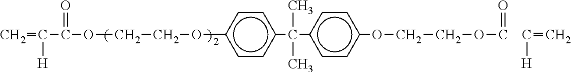 Ethoxylated (3) bisphenol A diacrylate, available from Sartomer, Exton, PA under trade designation “SR340” |
| SR423A | Isobornyl methacrylate, obtained from Sartomer, Exton PA under trade designation “SR423A” |
| SR205 | Triethylene glycol dimethacrylate, obtained from Sartomer, Exton PA under trade designation |
| | “SR205” |
| SR480 | Ethoxylated (10) bisphenol dimethacrylate, obtained from Sartomer, Exton, PA under trade |
| | designation “SR205” |
| Allyldimethylamine | Me₂NCH₂CH═CH₂, obtained from Sigma Aldrich, St. Louis, MO |
| Barrier Film | Primed PET barrier film, 2 mil (50 micrometer) barrier film obtained as FTB-M-50 from 3M, |
| | St. Paul, MN |
| PG-988 | amino-silicone, available from Genesee Polymers Corp, Flint, MI |
| SR833 | tricyclodecane dimethanol diacrylate available from Sartomer USA, LLC (Exton, PA) under |
| | trade designation “SR833”. |
| TPO-L | Ethyl-2,4,6-trimethylbenzoylphenylphosphinate, a liquid UV initiator, available from BASF |
| | Resins Wyandotte, MI under trade designation “LUCIRIN TPO-L”. |
| TEMPIC | 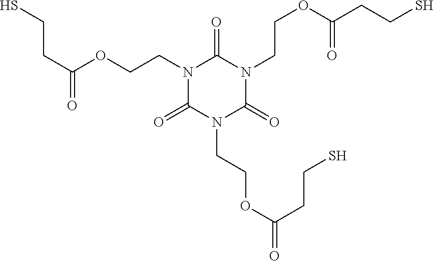 [SMILES: O=C(CCS)OCCn1c(=O)n(CCOC(=O)CCS)c(=O)n(CCOC(=O)CCS)c1=O] Tris[2-(3-mercaptopropionyloxy)ethyl] Isocyanurate [CAS#36196-44-8, MW = 525.62 (EW = 175.206)], available form Bruno Bock Chemische Fabrik GmbH & Co. KG (Marschacht, Germany) |
| TAIC | 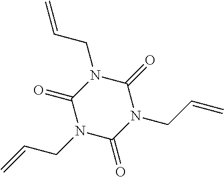 [SMILES: C=CCn1c(=O)n(CC=C)c(=O)n(CC=C)c1=O] Triallyl Isocyanurate [CAS#1025-15-6, MW = 249.27], available from TCI America (Portland, Oregon). |

All other reagents and chemicals were obtained from standard chemical suppliers and were used as received.

### Test Methods

% Transmission, Haze and Clarity were measured using a Byk HazeGuard Plus (obtained from BYK Gardner-Columbia, Md.).
Edge ingress (EI) was tested by placing the coatings on a black light and then measuring how much of the edge of the film is dark (does not illuminate) with a ruler.
External quantum efficiency (EQE) was measured by using an absolute PL Quantum Yield Spectrometer C11347 (Hamamatsu Corporation, Middlesex, N.J.). Aged EQE was measured in the same manner after aging the samples at a desired temperature (typically 85° C.) for an extended period of time (typically 7 days).
White point (color) was quantified by placing the constructed QDEF film into a recycling system (FIG. 4) and measuring with a colorimeter (available from Photo Research, Inc., Chatsworth, Calif., under the trade designation “PR650”). A gain cube with a blue LED light was used with the QDEF film, which contained red and/or green quantum dots, and a micro-replicated brightness enhancement film (available from 3M, St. Paul, Minn., under the trade designation “VIKUITI BEF”). A white point was achieved in the recycling system shown in FIG. 4.

Color was quantified by placing the constructed film 310 into a recycling system 300 (FIG. 4) and measuring with a colorimeter 302 available from Photo Research, Inc., Chatsworth, Calif., under the trade designation PR650. A gain cube 304 with a blue LED light was used with the film 310, which contained red and green quantum dots, and a micro-replicated brightness enhancement film 308 available from 3M, St. Paul, Minn., under the trade designation VIKUITI BEF. A white point was achieved in this recycling system.

Color was measured: (1) after a duration of operation in the blue light recycling system 300 of FIG. 4; (2) after a duration of use at 65° C./95% RH, and (3) after a duration of use at 85° C.

An initial white point after film construction was measured and quantified using the CIE1931 (x,y) convention normalized as zero. It is ideal for QDEF to maintain the same color during long-term operation. The failed QDEF is defined when the white point (Delta (x,y)) is higher than 0.010 in all accelerated aging tests. The effect was irreversible.

### Method for Accelerated Aging Test I (High Intensity Light Test—HILT)

The HILT test was carried out by subjecting the samples prepared by the Examples and Comparative Examples described below to a high intensity of incident blue light at a flux of 300 mW/cm² at a constant temperature of 70° C. The normalized EQE or brightness (initial as 100%) and color (i.e., Delta (x,y), initial as zero) versus aging time (hours) was determined as described above and plotted. The QDEF was considered failing when the normalized EQE or brightness drops to 85% of the initial value, normalized color higher than 0.010.

Note that these systems were designed to provide independent flux and temperature control by creating physical separation of the light source and sample chamber. The sample chamber was temperature controlled with a forced air method creating constant temperature air flow over the sample surfaces. While not wishing to be bound by theory, it was believed that although these systems have proven to be very reliable, they are limited by their optical design which does not allow recycling thus limiting the amount of flux acceleration they were capable of. In addition, although the forced air approach allowed for a stable temperature to be reached, it could not fully compensate for self-heating in the samples due to absorption of the incident blue flux. This would result in a temperature offset for the sample versus the ambient temperature.

### Method for Accelerated Aging Test II (Super High Intensity Light Test—SHILT)

The SHILT test was carried out by subjecting the samples prepared by the Examples and Comparative Examples described below to a super high intensity of incident blue light at a flux of 10,000 mW/cm² at a constant temperature of 50° C. The normalized EQE (initial EQE as 100%) versus aging time (hours) was determined as described above and plotted. The QDEF was considered failing when the normalized EQE or brightness drops to 85% of the initial value.

These systems were designed to help overcome the shortcomings of the HILTs described above. Although they are built on the same optical principles and thus can only perform a single pass through the sample, the illuminated spot size on the sample was reduced to increase the possible flux to 10,000 mW/cm². The system temperature was set at 50° C. In addition, a sapphire window was added to the sample holder to sandwich the sample and offer a direct path to the sample for temperature control. This enabled better temperature control even with the elevated incident fluxes.

### General Method for Preparing QDEF Film Samples

All coating compositions were formulated by fully mixing with a high shear impeller blade (a Cowles blade mixer) at 1400 rpm for 4 minutes in a nitrogen box. QDEF film samples were prepared by knife-coating the corresponding composition between two barrier films at a thickness of ˜100 um. Then the film samples were first partially cured by exposing them to 385 nm LED UV light (Clearstone Tech CF200 100-240V 6.0-3.5 A 50-60 Hz) at 50% power for 10 seconds in N₂ box, then fully cured by Fusion-D UV light with 70% intensity at 60 fpm under N₂.

### Examples 1-7 (EX1-EX7) and Control Example A (CE-A)

EX1-EX7 coating compositions were prepared by mixing various (meth)acrylates (2.81 g, 20 wt. %) with TAIC (11.22 g, 80 wt. %) in a vial by rotation for 30 minutes, then adding TEMPIC (26.65 g). To the resulting mixture, G-QD (1.4 g), R-QD (0.4 g) and TPO-L (0.21 g) was added in a nitrogen box.

CE-A coating composition was prepared in the same manner as EX1-EX7 except that it did not contain any (meth)acrylate and the amount of TAIC (14.8 g) and TEMPIC (28.2 g) was modified.

Each of EX1-EX7 and CE-A coating compositions were then formed into films using General Method for Preparing QDEF Film Samples as described above.

The EX1-EX7 and CE-A sample were tested for their initial transmission, haze, clarity and luminance using methods described above.

Table 1, below, summarizes the type of (meth)acrylate used and initial transmission, haze, clarity and EQE for EX1-EX7 and CE-A films.

TABLE 1

| | | % | | | |
|---|---|---|---|---|---|
| Example | (Meth)acrylate | Transmission | Haze | Clarity | EQE |
| CE-A | None | 89.2 | 99.4 | 11.6 | 92.0 |
| EX1 | SR339 | 88.4 | 98.8 | 11.0 | 90.8 |
| EX2 | SR340 | 91.6 | 95.3 | 18.0 | 88.5 |
| EX3 | SR348 | 90.3 | 98.9 | 12.7 | 89.7 |
| EX4 | SR349 | 84.0 | 101.0 | 6.9 | 92.0 |
| EX5 | SR423A | 84.7 | 101 | 6.3 | 84.4 |
| EX6 | SR480 | 84 | 101 | 5.4 | 86.1 |
| EX7 | SR205 | 89.1 | 100.3 | 6.9 | 84.3 |

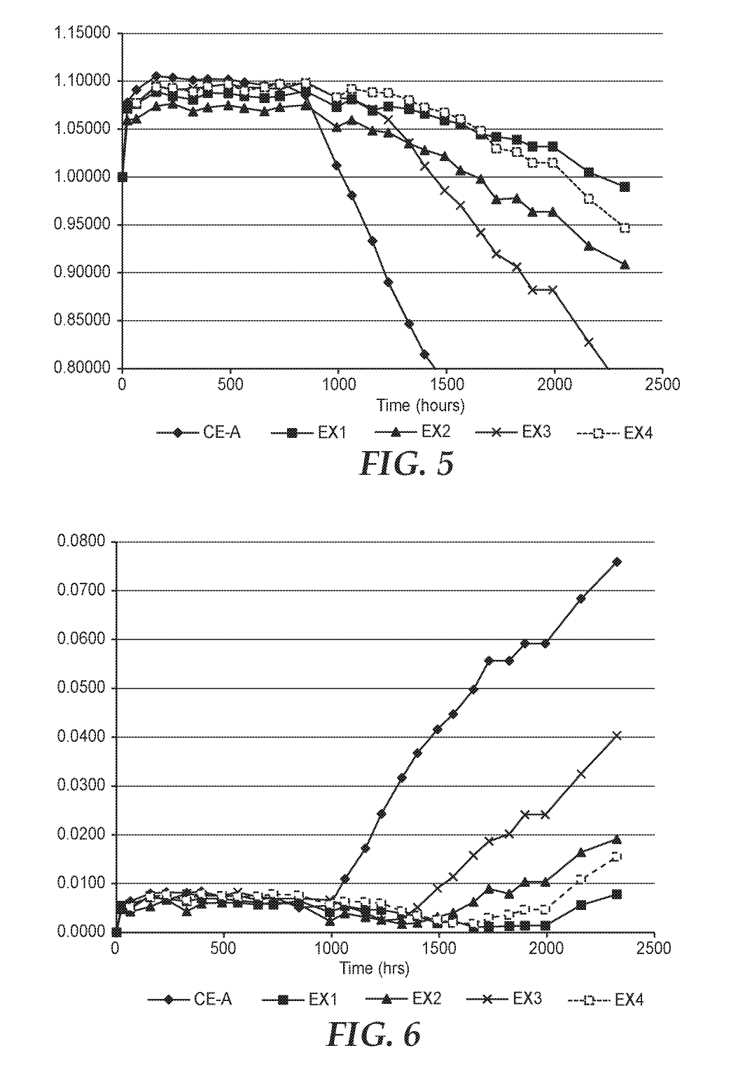

The EX1-EX4 and CE-A sample were tested using “Accelerated Aging Test I (High Intensity Light Test—HILT)” described above. FIG. 5 is normalized EQE versus time of EX1-EX4 and CE-A from Accelerated Aging Test I (HILT). FIG. 6 is normalized Delta (x, y) versus time of EX1-EX4 and CE-A from Accelerated Aging Test I (HILT).

### Examples 8-9 (EX8-EX9) and Control Example B (CE-B)

EX8 coating composition was prepared in the same manner as EX1-EX7 described above except that SR339 (1 g) was mixed with TAIC (9 g) and then TEMPIC (20 g) was added. To the resulting mixture, QD (1.5 g, a mixture of 1.2 g G-QD and 0.3 g R-QD) and TPO-L (0.3 g) was added in a nitrogen box.

EX9 coating composition was the same as EX8 except that SR349 was used instead of SR339.

CE-B coating composition was prepared in the same manner as EX8 except that it did not contain any (meth)acrylate and the amount of TAIC (10 g) was modified.

Each of EX8-EX9 and CE-B coating compositions were then formed into films using General Method for Preparing QDEF Film Samples as described above.

The initial EQE, aged EQE and aged EI (after aging in an 85° C. oven for 7 days) of EX8-EX9 and CE-B were determined using the test methods described above and are reported in Table 2, below.

TABLE 2

| | Initial EQE | Aged EI | Aged EQE |
|---|---|---|---|
| Example | (%) | (mm) | (%) |
| EX8 | 94.4 | 0.25 | 93.2 |
| EX9 | 93.0 | 0.25 | 90.6 |
| CE-B | 94.5 | 0.25 | 93.4 |

### Control Example C (CE-C)

CE-C was run to understand the mechanism by which (meth)acrylate enhanced the photo lifetime stability. TEMPIC (26.65 g) and SR339 (2.8 g) was pre-reacted in TAIC (14.03 g) as solvent. The reaction was catalyzed by allyldimethylamine (0.15 g) and run at room temperature in dark for 2 hours as shown below. FTIR analysis showed almost no acrylate signal after reaction.

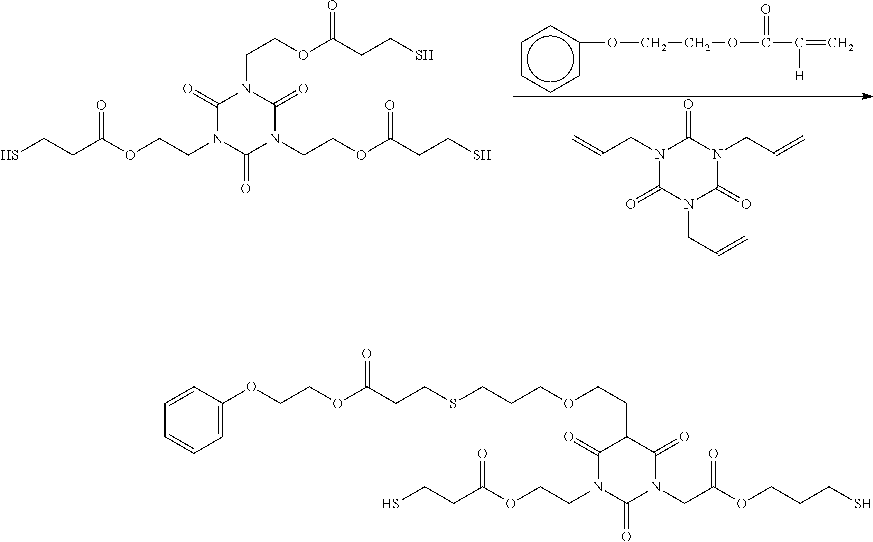

To the resulting mixture G-QD (1.4 g), R-QD (0.4 g) and TPO-L (0.25 g) was added in a nitrogen box to forming the coating composition of CE-C which was then formed into films using General Method for Preparing QDEF Film Samples as described above.

The CE-C and CE-A sample were tested for their T_{g}, aged (85° C., for 7 days) EQE and EI using methods described above. The data is summarized in Table 3, below.

TABLE 3

| Example | Tg (° C.) | EQE (aged) | EI (mm, aged) |
|---|---|---|---|
| CE-A | 49.8 | 93 | 0.1 |
| CE-C | 7.0 | 67 | 0.5 |

From the data in Table 3, CE-C had a significant reduction in the matrix T_{g} due to reduced crosslinking and correspondingly the reduction of thermal stability as seen from lower EQE and increased edge ingress after aging in 85° C. oven for 7 days. While not wishing to be bound by theory, these results indicated that the Michael addition of (meth)acrylate with polythiol was not good for QDEF performance and stability and should not be the reason for observed enhancement of photo lifetime stability under accelerated aging test.

### Preparative Examples I and II (PE-I and PE-II)

PE-I and PE-II were run by pre-reacting GP988 with SR339 according to the Michael addition reaction shown below. The reaction was carried out at 50° C. for 0.5 hr.

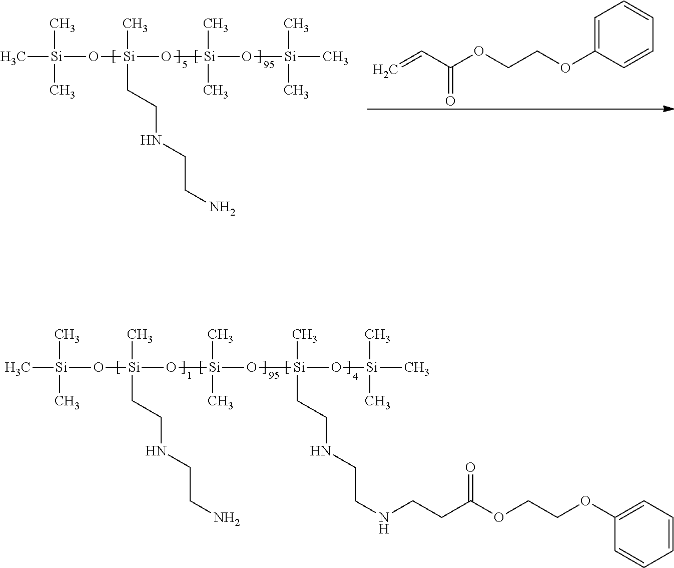

For PE-I, GP988 (16 g) was reacted with SR339 (1.6 g) modifying ˜80 mol % of —NH₂ with SR339.

For PE-II, GP988 (16 g) was reacted with excess SR339 (3.0 g) modifying all of the —NH₂with SR339.

### Example 10 and 11 (EX10 and EX11)

EX10 coating composition was prepared by pre-mixing PE-I material (0.9 g) with G-QD (1.4 g) and R-QD (0.4 g) for 5 minutes under nitrogen, then adding TEMPIC (26.65 g), TAIC (14.03 g) and TPO-L (0.21 g) in the same manner as described above for EX1-EX7. The EX10 coating composition was then formed into films using General Method for Preparing QDEF Film Samples as described above.

EX11 was prepared in the same manner as EX10 except that the EX11 coating composition was prepared by pre-mixing PE-II material (0.9 g) with G-QD (1.4 g) and R-QD (0.4 g) for 5 minutes.

EX10-EX11 and CE-A samples were tested for their initial EQE as well as aged (85° C. for 7 days) EQE and EI as described above. The results are summarized in Table 4, below.

TABLE 4

| Example | Initial EQE | Initial Abs | EI (Aged) | EQE (Aged) | Abs (Aged) |
|---|---|---|---|---|---|
| CE-A | 97.4% | 35.0% | ~0.1 mm | 99.5% | 35.2% |
| EX10 | 98.4% | 35.8% | ~0.1 mm | 100.0% | 37.0% |
| EX11 | 96.7% | 33.3% | ~0.1 mm | 95.1% | 34.0% |

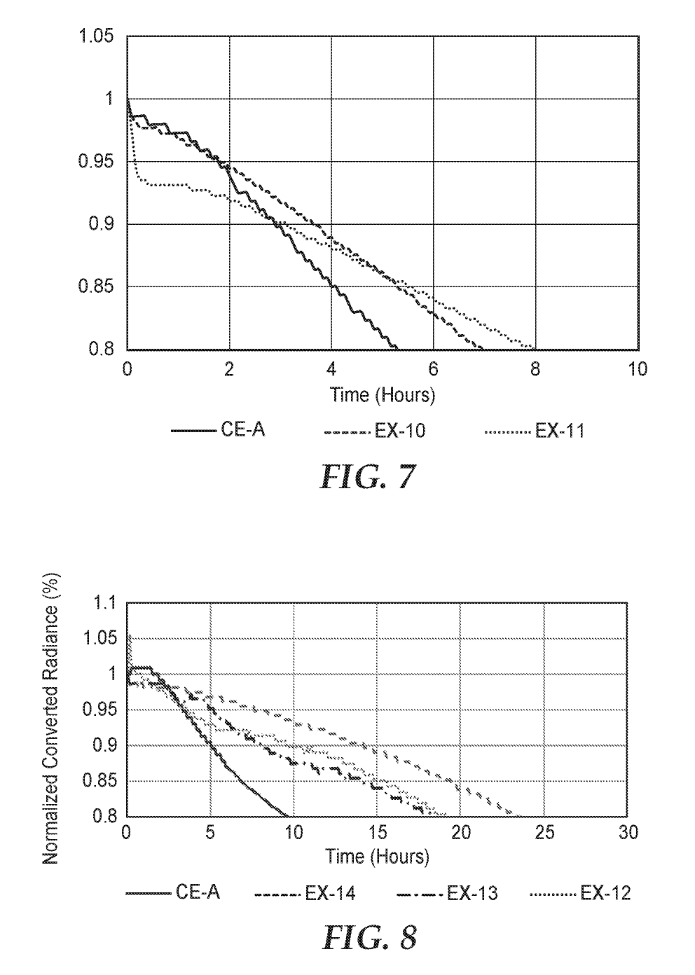

The EX10-EX11 and CE-A sample were tested using “Accelerated Aging Test (Super High Intensity Light Test II—SHILT)” described above. FIG. 7 is normalized EQE versus time of EX10-EX11 and CE-A from Accelerated Aging Test II (SHILT).

### Examples 12-14 (EX12-EX14)

EX12 coating composition was prepared by mixing SR339 (1.80 g) with TAIC (14.82 g) in a vial by rotation for 30 minutes, then adding TEMPIC (26.65 g). To the resulting mixture, G-QD (1.4 g), R-QD (0.4 g) and TPO-L (0.21 g) was added in a nitrogen box.

EX13 coating composition was prepared by pre-mixing SR339 (7.2 g) with QD (7.2 g, a mixture of 5.6 g G-QD and 1.6 g R-QD) at room temperature for 5 minutes by rotation in a nitrogen box. Then 3.6 g of the resulting mixture was formulated by adding TAIC (14.82 g), TEMPIC (26.65 g) and TPO-L (0.21 g) added in a nitrogen box. EX14 was prepared in the same manner as EX13 except that SR339 and QD were premixed for 60 mins.

EX12-EX14 coating compositions were then formed into films using General Method for Preparing QDEF Film Samples as described above.

EX12-EX14 and CE-A sample were tested using “Accelerated Aging Test (Super High Intensity Light Test II—SHILT)” described above. FIG. 8 is normalized EQE versus time of EX10-EX11 and CE-A from Accelerated Aging Test II (SHILT).

While not wishing to be bound by theory, from the data for EX12-EX14 and CE-A, it was confirmed that the pre-mixing (meth)acrylate with amino-silicone stabilized quantum dots was a simple and practical approach for improving thiol-ene based QDEF photo lifetime stability. The mixing time of acrylate with amino-silicone stabilized quantum dots for completing the Michael addition reaction was critical for best photo lifetime stability.

1. A liquid quantum dot composite comprising fluorescent core-shell nanoparticles stabilized with a first ligand of the formula: 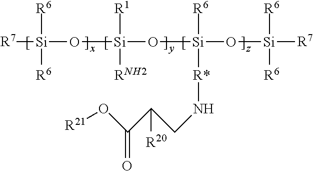
each R⁶ is independently an alkyl or aryl;
R^{NH2} is an amine-substituted (hetero)hydrocarbyl group;
R* is a (hetero)hydrocarbyl group;
R²⁰ is H or C1-C4 alkyl;
R²¹ is a hydrocarbyl group, including alkyl and aryl or a a silyl-substituted hydrocarbyl group;
x is 1 to 2000; preferably 3 to 100;
y may be zero;
x+y is at least one;
z is at least one;
R⁷ is alkyl, aryl or R^{NH2} or 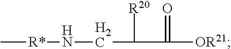
wherein amine-functional silicone has at least two R^{NH2} groups.

2. The composite of claim 1, further comprising a secondary ligand of the formula:
R¹⁵—R¹²(X)ₙ
wherein
R¹⁵ is (hetero)hydrocarbyl group having C₂ to C₃₀ carbon atoms;
R¹² is a hydrocarbyl group including alkylene, arylene, alkarylene and aralkylene;
n is at least one;
X is a ligand group, including —CO₂H, —SO₃H, —P(O)(OH)₂, —OP(O)(OH), —OH—SH and —NH₂.

3. The composite of claim 2 wherein X is —NH₂.

4. The composite of claim 1, further comprising a secondary aminosilicone ligand of the formula: 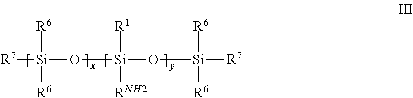
wherein
each R⁶ is independently an alkyl or aryl;
R^{NH2} is an amine-substituted (hetero)hydrocarbyl group;
x is 1 to 2000; preferably 3 to 100;
y may be zero;
x+y is at least one;
R⁷ is alkyl, aryl or R^{NH2}
wherein amine-functional silicone has at least two R^{NH2} groups.

5. The composite of claim 1 wherein the first ligand is obtained by Michael addition of an aminosilicone to a (meth)acrylate ester, said aminosilicone of the formula: 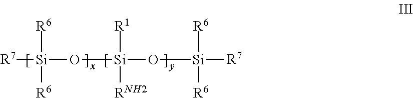
wherein
each R⁶ is independently an alkyl or aryl;
R^{NH2} is a n amine-substituted (hetero)hydrocarbyl group;
x is 1 to 2000; preferably 3 to 100;
y may be zero;
x+y is at least one;
R⁷ is alkyl, aryl or R^{NH2}
wherein amine-functional silicone has at least two R^{NH2} groups.

6. The composite of claim 1 wherein the core of the core-shell nanoparticle comprises InP, CdS or CdSe.

7. The composite of claim 1 wherein the shell of the core-shell nanoparticle comprises a magnesium or zinc-containing compound.

8. The composite of claim 1 wherein the shell of the core-shell nanoparticle is a multilayered shell.

9. The composite of claim 8 wherein the multilayered shell comprises an inner shell overcoating the core, wherein the inner shell comprises zinc selenide and zinc sulfide.

10. The composite of claim 8 wherein the multilayered shell comprises an outer shell overcoating the inner shell, wherein the outer shell comprises zinc sulfide or MgS.

11. A composition comprising the composite of claim 1 comprising droplets of the quantum dots in the first ligand.

12. The composite of claim 1 wherein R²¹ is R^{Silyl}, a silyl-substituted hydrocarbyl group.

13. The composite of claim 1 wherein the ratio of subscripts y to z is 4:1 to 1:9.

14. The composite of claim 1 wherein R²¹ is a silyl-substituted hydrocarbyl group, including siloxane-substituted hydrocarbyl.

15. A curable composition comprising the composite of claim 1 and a thiol-ene resin.

16. The composition of claim 15 wherein the thiol-ene is derived from at least one polythiol and at least one polyene, each having a functionality ≥2.

17. The composition of claim 16 wherein the polyene is of the formula:
R¹CR¹⁰═CHR¹¹]ₓ,
where
R¹ is a polyvalent (hetero)hydrocarbyl group,
each of R¹⁰ and R¹¹ are independently H or C₁-C₄ alkyl;
and x is ≥2.

18. The composition of claim 17 wherein the polyene is a triallyl isocyanurate.

19. The composition of claim 17 wherein R¹ is an cyclic aliphatic group, optionally containing one or more consisting of esters, amides, ethers, thioethers, urethanes, urea functional groups, and x is ≥2.

20. The composition of claim 17 wherein R¹ is an aliphatic or aromatic group, optionally containing one or more consisting of esters, amides, ethers, urethane, thioether, urea functional groups, and x is ≥2.

21. The composition of claim 15 wherein the polythiol is of the formula:
R^{2(SH)}_{w}, where R² is (hetero)hydrocarbyl group having a valence of w, and w is ≥2.

22. The composition of claim 21 where R² is an aliphatic or aromatic group, optionally containing one or more consisting of esters, amides, ethers, urethane, thioethers, and urea functional groups.

23. The composition of claim 21 where R² is an aliphatic, cycloaliphatic, aromatic or alkyl-substituted aromatic moiety having from 1 to 30 carbon atoms and optionally 1 to 4 catenary heteroatoms of oxygen, nitrogen or sulfur.

24. The composition of claim 21 wherein said polythiol is obtained by esterification of a polyol with a terminally thiol-substituted carboxylic acid.

25. A quantum dot composite coating composition comprising:
a) a first component quantum dot composite comprising fluorescent nanoparticles stabilized with a first ligand of the formula: 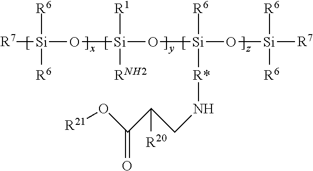
each R⁶ is independently an alkyl or aryl;
R^{NH2} is an amine-substituted (hetero)hydrocarbyl group;
R* is a (hetero)hydrocarbyl group;
R²⁰ is H or C₁-C₄ alkyl;
R²¹ is a hydrocarbyl group, including alkyl and aryl or a silyl-substituted hydrocarbyl group;
x is 1 to 2000; preferably 3 to 100;
y may be zero;
x+y is at least one;
z is at least one;
R⁷ is alkyl, aryl or R^{NH2} or 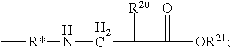
wherein the first ligand has at least two R^{NH2} groups; and
b) a second component comprising a thiol-ene resin.

26. The coating composition of claim 25 weight ratio of the quantum dot composite to thiol-ene resin is from 1:99 to 20:80.

27. The coating composition of claim 25 wherein the ratio of subscripts y to z is 4:1 to 1:9.

28. A quantum dot coating composition comprising;
a) a first component comprising a quantum dot composite comprising fluorescent nanoparticles stabilized with a aminosilicone ligand and a (meth)acrylate ester; said aminosilicone ligand of the formula: 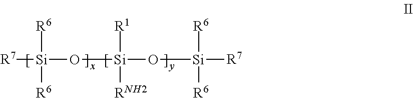
wherein
each R⁶ is independently an alkyl or aryl;
R^{NH2} is a n amine-substituted (hetero)hydrocarbyl group;
x is 1 to 2000; preferably 3 to 100;
y may be zero;
x+y is at least one;
R⁷ is alkyl, aryl or R^{NH2}
wherein amine-functional silicone has at least two R^{NH2} groups; and
b) a second component comprising a thiol-ene resin.

29. The coating composition of claim 28 wherein the weight ratio of (meth)acrylate to the quantum dot composite in the first component is from 0.5:1 to 3:1.

30. A quantum dot coating composition comprising;
a) a first component comprising a quantum dot composite comprising fluorescent nanoparticles stabilized with a aminosilicone ligand, said aminosilicone is of the formula: 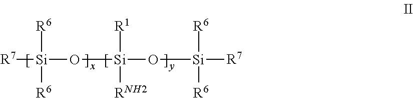
wherein
each R⁶ is independently an alkyl or aryl;
R^{NH2} is a n amine-substituted (hetero)hydrocarbyl group;
x is 1 to 2000; preferably 3 to 100;
y may be zero;
x+y is at least one;
R⁷ is alkyl, aryl or R^{NH2}
wherein amine-functional silicone has at least two R^{NH2} groups and
b) a second component comprising a thiol-ene resin and a (meth)acrylate ester.

31. The coating composition of claim 30 wherein the weight ratio of (meth)acrylate ester to ene of the thiol-ene resin in the second component is 5:95 to 40:60.

32. A ligand of the formula: 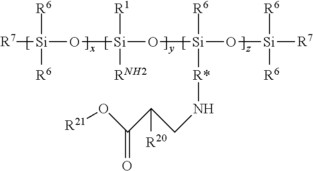
each R⁶ is independently an alkyl or aryl;
R^{NH2} is an amine-substituted (hetero)hydrocarbyl group;
R* is a (hetero)hydrocarbyl group;
R²⁰ is H or C₁-C₄ alkyl;
R²¹ is a hydrocarbyl group, including alkyl and aryl or a a silyl-substituted hydrocarbyl group;
x is 1 to 2000; preferably 3 to 100;
y may be zero;
x+y is at least one;
z is at least one;
R⁷ is alkyl, aryl or R^{NH2} or 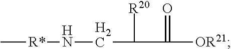
wherein amine-functional silicone has at least two R^{NH2} groups.

33. The ligand of claim 32 wherein the ratio of subscripts y to z is 4:1 to 1:9.

34. The ligand of claim 32 of the formula: 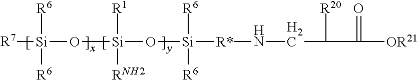
wherein
each R⁶ is independently an alkyl or aryl;
R^{NH2} is an amine-substituted (hetero)hydrocarbyl group;
R* is a (hetero)hydrocarbyl group;
R²⁰ is H or C₁-C₄ alkyl;
R²¹ is a hydrocarbyl group, including alkyl and aryl or a a silyl-substituted hydrocarbyl group;
x is 1 to 2000; preferably 3 to 100;
y may be zero;
x+y is at least one;
z is at least one.

35. The ligand of claim 32 of the formula: 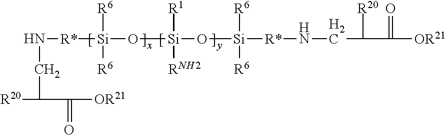
wherein
each R⁶ is independently an alkyl or aryl;
R^{NH2} is an amine-substituted (hetero)hydrocarbyl group;
R* is a (hetero)hydrocarbyl group;
R²⁰ is H or C₁-C₄ alkyl;
x is 1 to 2000; preferably 3 to 100;
y may be zero;
x+y is at least one;
z is at least one.
